(19) United States
(12) Patent Application Publication
(10) Pub. No.: US 2025/0333337 A1
(43) Pub. Date: Oct. 30, 2025

(54) METAL CATION REMOVAL FROM LIQUID STREAMS USING CAPTURED CARBON DIOXIDE

(71) Applicant: Eleryc, Inc., Campbell, CA (US)

(72) Inventors: Ian Robinson, San Jose, CA (US); David Koshy, San Mateo, CA (US); Sahag Voskian, Campbell, CA (US); Kyle Weldon Self, San Jose, CA (US)

(73) Assignee: Eleryc, Inc., Campbell, CA (US)

(21) Appl. No.: 19/191,990

(22) Filed: Apr. 28, 2025

Related U.S. Application Data
(60) Provisional application No. 63/640,084, filed on Apr. 29, 2024.
(60) Provisional application No. 63/687,639, filed on Aug. 27, 2024.

(51) Int. Cl. C02F 1/52; C02F 1/461; C02F 1/469; C02F 101/10

(52) U.S. Cl. CPC C02F 1/5236; C02F 1/46104; C02F 1/4693; C02F 1/5209; C02F 2101/10; C02F 2201/46115; C02F 2201/4618; C02F 2209/24

(57) ABSTRACT

Systems and methods for removing metal cation impurities such as alkaline earth metal cations via exposure to captured carbon dioxide are generally described. The captured carbon dioxide, which may be in the form of dissolved carbonate anions, may induce the formation of solid alkaline earth metal (e.g., as a precipitated salt), thereby removing a relatively high percentage of dissolved alkaline earth metals. The carbon dioxide may be captured in a gas-liquid contact vessel and then transferred to a component of the system where metal cation impurity removal is performed. The systems and methods can be useful for treating (or pre-treating) liquid streams such as brines or wastewaters and/or for softening liquid streams.

### RELATED APPLICATIONS

This application claims priority under 35 U.S.C. § 119(e) to U.S. Provisional Patent Application No. 63/640,084, filed Apr. 29, 2024, and entitled “Metal Cation Removal From Liquid Streams Using Captured Carbon Dioxide,” and to U.S. Provisional Patent Application No. 63/687,639, filed Aug. 27, 2024, and entitled “Metal Cation Removal From Liquid Streams Using Captured Carbon Dioxide,” each of which is incorporated herein by reference in its entirety for all purposes.

### TECHNICAL FIELD

Systems and methods for removing metal ion impurities via exposure to captured carbon dioxide are generally described.

### BACKGROUND

Metal cation impurities are present in numerous aqueous sources. It can be desirable to remove these impurities in some instances. Accordingly, improved methods and systems for removing dissolved metal cation impurities from aqueous solutions are desirable.

### SUMMARY

Systems and methods for removing metal cation impurities such as alkaline earth metal cations via exposure to captured carbon dioxide are generally described. The subject matter of the present invention involves, in some cases, interrelated products, alternative solutions to a particular problem, and/or a plurality of different uses of one or more systems and/or articles.

In one aspect, a method for removing dissolved metal cation impurities from an aqueous stream is provided. In some embodiments, the method comprises exposing an aqueous metal cation impurity-rich source stream comprising dissolved metal cation impurities present at a total concentration of greater than or equal to 0.001 mg/L to a metal cation impurity salt precipitation stream to produce a metal cation impurity solids-containing stream comprising a solid salt comprising at least some of the metal cation impurities; wherein the metal cation impurity salt precipitation stream is formed at least in part by a method comprising: exposing, in a gas-liquid contact vessel, basic species to carbon dioxide from an input gas stream to generate: a carbon dioxide-lean output gas stream having a lower concentration of carbon dioxide than the input gas stream; and a capture stream comprising dissolved carbonate anions formed from the carbon dioxide; and transporting at least a portion of the capture stream out of the gas-liquid contact vessel to form at least a portion of the metal cation impurity salt precipitation stream; wherein a ratio of the molar concentration of at least one dissolved metal cation impurity in the aqueous metal cation impurity-rich source stream to the molar concentration of the at least one dissolved metal cation impurity in the metal cation impurity solids-containing stream is greater than or equal to 2.

In another aspect, a system for removing dissolved metal cation impurities from an aqueous stream is provided. In some embodiments, the system is configured to perform a method as described in this disclosure.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a schematic diagram of an example of a system for removing metal cation impurities using a metal cation impurity salt precipitation stream comprising carbonate anions from captured carbon dioxide, according to some embodiments;

FIG. 1B shows a schematic diagram of an example of a system for removing metal cation impurities using a metal cation impurity salt precipitation stream comprising carbonate anions from captured carbon dioxide, the system further comprising a solids separation vessel, according to some embodiments;

FIG. 2 shows a schematic diagram of an example of a system for removing metal cation impurities using a metal cation impurity salt precipitation stream comprising carbonate anions from captured carbon dioxide, where the carbon dioxide is captured using electrogenerated basic species, according to some embodiments;

FIG. 3A shows a schematic cross-sectional diagram of an electrolytic cell in which an aqueous input stream is transported to a catholyte chamber, according to some embodiments;

FIG. 3B shows a schematic cross-sectional diagram of an electrolytic cell in which an aqueous input stream is transported to an anolyte chamber, according to some embodiments;

FIG. 3C shows a schematic cross-sectional diagram of an electrolytic cell in which an aqueous input stream is transported to an electrolyte chamber, according to some embodiments;

FIG. 3D shows a schematic cross-sectional diagram of an electrolytic cell configured as an electrodialysis cell and comprising a bipolar membrane, according to some embodiments; and

FIG. 3E shows a schematic cross-sectional diagram of an electrolytic cell configured as an electrodialysis cell and comprising a bipolar membrane, according to some embodiments.

### DETAILED DESCRIPTION

Systems and methods for removing metal cation impurities such as alkaline earth metal cations via exposure to captured carbon dioxide are generally described. The captured carbon dioxide, which may be in the form of dissolved carbonate anions, may induce the formation of solid metal cation impurity salts (e.g., as a precipitated salt), thereby removing a relatively high percentage of dissolved alkaline earth metals. The carbon dioxide may be captured in a gas-liquid contact vessel and then transferred to a component of the system where metal cation impurity removal is performed. The systems and methods can be useful for treating (or pre-treating) liquid streams such as brines or wastewaters and/or for softening liquid streams.

Metal cation impurities such as alkaline earth metal cations, heavy metal cations, and/or transition metal cations are present in numerous aqueous sources. It is often desirable to remove these species to, for example, facilitate the removal of an aqueous species remaining in solution, prevent scaling and precipitation of these cations in downstream processes, and/or directly utilize certain valuable precipitated metals. A variety of technologies can be used to remove these cations (in some instances selectively). Some such techniques operate via precipitation reactions that exploit the insolubility of certain metal compounds such as metal carbonates. These methods may rely on stoichiometric addition of externally-sourced soluble carbonates to remove these undesired cations. It has been realized in the context of this disclosure that the coupling of metal cation impurity removal to carbon dioxide capture can result in a relatively more efficient process. For example, the carbon dioxide capture, which may be performed at least in part by a pH change-induced dissolution of the carbon dioxide, may involve safe, abundant reagents (e.g., ambient air and abundant salts such as sodium chloride, potassium chloride, and/or an alkali dihydrogen phosphate) to produce a precipitating agent. By contrast, other approaches may use harsh conditions/reagents and/or high energy inputs. The approach described in this disclosure, in addition to in some instances providing a low-energy and/or continuous process for undesired cation removal, may improve the economic viability of the environmentally-important process of carbon dioxide capture.

Aspects of this disclosure are directed to systems and methods for removing dissolved metal cation impurities from an aqueous stream. The system may be configured to expose an aqueous metal cation impurity-rich source stream to a metal cation impurity salt precipitation stream (e.g., by mixing portions or all of each). The system may produce the metal cation impurity salt precipitation stream by transporting a basic species and an input gas stream comprising carbon dioxide to a gas-liquid contact vessel, thereby capturing at least some of the carbon dioxide and generating carbonate anions (CO₃²⁻). The carbonate anions may be transported from the contact vessel as the metal cation impurity salt precipitation stream to elsewhere in the system to mix with the aqueous metal cation impurity-rich stream. Precipitation may result in a solid salt of an alkaline earth metal (e.g., as a slurry). The solid salt may then be separated from the stream.

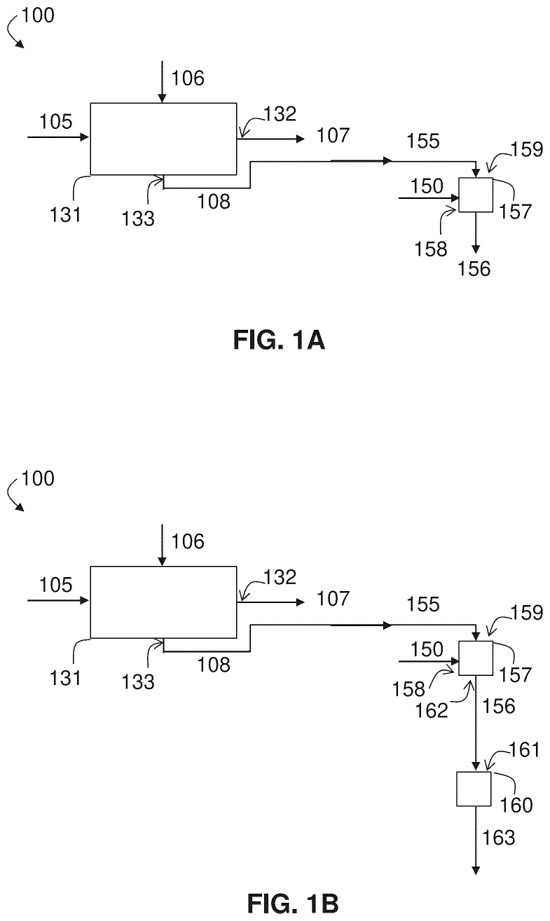

As an example, FIG. 1A shows a schematic diagram of system 100, which comprises gas-liquid contact vessel 131 configured to receive input gas stream 105 and contact vessel liquid inlet stream 106 (e.g., comprising basic species) and to output carbon dioxide-lean output gas stream 107 and capture stream 108. At least a portion of capture stream 108, which may comprise dissolved carbonate anions, may form some or all of metal cation impurity salt precipitation stream 155. Metal cation impurity salt precipitation stream 155 may be exposed to aqueous metal cation impurity-rich stream 150 to produce metal cation impurity solids-containing stream 156. Details of the components, connectivity, operation, and related chemistries of various embodiments are described in more detail below.

As noted above, in some embodiments, an aqueous metal cation impurity-rich source stream is treated. The aqueous metal cation impurity-rich source stream may be or be derived from any of a variety of streams, such as, but not limited to a brine (e.g., a natural brine), wastewater (e.g., industrial wastewater), groundwater, sewage, seawater, acidulated/digested minerals, salt flats, and/or industrial process streams (e.g., electroplating baths, cooling water). For example, the methods of this disclosure may be employed to remove heavy metal contamination in industrial wastewater (e.g., lead, cadmium, certain transition metals). As another example, the methods of this disclosure may be employed to remove calcium from aqueous process streams to reduce or prevent scaling of process equipment. As another example, the methods of this disclosure may be employed for resource recovery of valuable cations in process streams, nickel/copper from mining streams, electroplating baths, and/or catalyst/battery recycling. As yet another example, the methods of this disclosure may be employed to increase the efficiency of a downstream separation process, such as removing magnesium and/or calcium when recovering other species from natural brines.

The aqueous metal cation impurity-rich source stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the metal cation impurity-rich source stream.

The aqueous metal cation impurity-rich source stream may include a relatively high concentration of dissolved metal cation impurities. For example, the aqueous metal cation impurity-rich source stream may comprise dissolved metal cation impurity salts. When a salt is dissolved, its constituents (e.g., a cation and an anion) may each be solvated (e.g., by solvent molecules such as water molecules) such that the constituents are no longer ionically bonded to each other. Accordingly, when referring to a dissolved or aqueous salt, the reference corresponds to the collection of dissolved constituents.

The term “metal cation impurity” refers to a metal cation species for which the methods and systems of this disclosure are employed to remove at least some of the species from the aqueous metal cation impurity-rich source stream, and is not intended to imply any particular relative or absolute amount of the species in an stream or any particular commercial value (or lack thereof) of the species. As an illustrative example, if the aqueous metal cation impurity-rich stream contains dissolved potassium cations, sodium cations, and calcium cations, and the methods or systems of this disclosure are employed to remove some or all of the calcium cations (e.g., as a calcium carbonate precipitate), then the calcium cations would be considered to be metal cation impurities.

Any of a variety of metal cation impurities may be present. In some, but not necessarily all embodiments, the carbonate salt of the metal cation impurity has a relatively low solubility in pure water. Having a low solubility may promote an ability to use carbonate anions (e.g., from dissolved carbon dioxide) as a precipitant to remove the metal cation impurity. In some embodiments, the carbonate salt of the metal cation impurity has a solubility in pure water of less than or equal to 0.1 g/100 mL, less than or equal to 0.05 g/100 mL, less than or equal to 0.02 g/100 mL, less than or equal to 0.01 g/100 mL, less than or equal to 0.005 g/100 mL, less than or equal to 0.002 g/100 mL, less than or equal to 0.001 g/100 mL, less than or equal to 0.0001 g/100 mL, less than or equal to 0.00001, less than or equal to 0.000001, or less at 298 K.

In some, but not necessarily all embodiments, the hydroxide salt of the metal cation impurity has a relatively low solubility in pure water. Having a low solubility may promote an ability to use hydroxide anions (e.g., produced electrochemically or otherwise) as a precipitant to remove the metal cation impurity. In some embodiments, the hydroxide salt of the metal cation impurity has a solubility in pure water of less than or equal to 0.1 g/100 mL, less than or equal to 0.05 g/100 mL, less than or equal to 0.02 g/100 mL, less than or equal to 0.01 g/100 mL, less than or equal to 0.005 g/100 mL, less than or equal to 0.002 g/100 mL, less than or equal to 0.001 g/100 mL, less than or equal to 0.0001 g/100 mL, or less at 298 K.

In some embodiments, the metal cation impurities comprises alkaline earth metals, transition metals, and/or heavy metals. In some embodiments, some (e.g., at least 1 mole percent (mol %), at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are alkaline earth metal cations. The alkaline earth metal cations may comprise magnesium cations (Mg²⁺), calcium cations (Ca²⁺), strontium cations (Sr²⁺), and/or barium cations (Mg²⁺). In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the alkaline earth metal cations are magnesium cations or calcium cations. In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the alkaline earth metal cations are magnesium cations. In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the alkaline earth metal cations are calcium cations.

In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are transition metal cations. Examples of transition metal cations that may be metal cation impurities in this disclosure include, but are not limited to scandium cations (e.g., Sc³⁺), titanium cations (e.g., Ti²⁺), vanadium cations (e.g., V²⁺, V⁴⁺), chromium cations (e.g., Cr³⁺), manganese cations (e.g., Mn²⁺, Mn³⁺), iron cations (e.g., Fe²⁺, Fe³⁺), cobalt cations (e.g., Co²⁺, Co³⁺), copper cations (e.g., Cu²⁺), and/or nickel cations (e.g., Ni²⁺).

In some embodiments, some (e.g., at least 1 mol %, at least 2 mol %, at least 5 mol % at least 10 mol %, at least 25 mol %, at least 50 mol %, at least 75 mol %, at least 95 mol %, at least 98 mol %, at least 99 mol %) or all of the metal cation impurities are heavy metal cations. Examples of heavy metal cations that may be metal cation impurities in this disclosure include, but are not limited to zinc cations (e.g., Zn²⁺), aluminum cations (e.g., Al³⁺), cadmium cations (e.g., Cd²⁺), tin cations (e.g., Sn²⁺, Sn⁴⁺), lead cations (e.g., Pb²⁺, Pb⁴⁺), bismuth cations (e.g., Bi³⁺), and/or arsenic cations (e.g., As³⁺.

As noted above, the dissolved metal cation impurities may be present in the aqueous metal cation impurity-rich source stream at a relatively high concentration. In some embodiments, the dissolved metal cation impurities are present in the aqueous alkaline earth metal-rich source stream at a total concentration of greater than or equal to 0.001 mg/L, greater than or equal to 0.01 mg/L, greater than or equal to 0.1 mg/L, greater than or equal to 0.5 mg/L, greater than or equal to 1 mg/L, greater than or equal to 5 mg/L, greater than or equal to 10 mg/L, greater than or equal to 20 mg/L, greater than or equal to 50 mg/L, greater than or equal to 100 mg/L, greater than or equal to 500 mg/L, greater than or equal to 1,000 mg/L, greater than or equal to 5,000 mg/L, greater than or equal to 10,000 mg/L, and/or up to 50,000 mg/L, up to 100,000 mg/L, up to 250,000 mg/L, or more. Combinations of these ranges (e.g., greater than or equal to 0.001 mg/L and less than or equal to 250,000 mg/L, greater than or equal to 1 mg/L and less than or equal to 100,000 mg/L) are possible. In some embodiments, at least one metal cation impurity is present in the aqueous metal cation impurity-rich source stream is present in one of the aforementioned concentration ranges. For example, in some embodiments, the concentration of calcium cations and/or the concentration of magnesium cations in the aqueous metal cation impurity-rich solid stream are each in one of the aforementioned concentration ranges.

In some embodiments, dissolved magnesium cations are present in the aqueous alkaline earth metal-rich source stream at a concentration of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, dissolved calcium cations are present in the aqueous alkaline earth metal-rich source stream at a total concentration of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, the aqueous metal cation impurity-rich source stream comprises dissolved anions. Any of a variety of anions may be present. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates, nitrites, and/or perchlorates. In some embodiments, the monovalent anions comprise hydrogen sulfate ions (HSO₄⁻). In some embodiments, the anions comprise oxyanions. In some embodiments, the anions comprise divalent ions (carrying a charge of −2). For example, the anions may comprise sulfate ions (SO₄²⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄⁻)). In some embodiments, the anions comprise borate ions (e.g., orthoborate ions (BO₃³⁻), tetrahydroxyborates (B(OH)₄⁻), tetraborates (B₄O₇²⁻), and/or polyborates). In some embodiments, the anions are conjugate bases of strong acids. However, in some embodiments, the anions are conjugate bases of weak acids. In some embodiments, the anions are spectator ions with respect to the chemistries employed to remove the metal cation impurities and/or other reactions performed in the methods and systems of this disclosure. In some embodiments, some (e.g., at least 50 mole percent (mol %), at least 75 mol %, at least 95 mol %, at least 98 mol %, at least 99 mol %) or all of the anions are chloride ions.

As noted above, the anions may be present in the aqueous metal cation impurity-rich source stream in a relatively high concentration. In some embodiments, the dissolved anions are present in the aqueous metal cation impurity-rich source stream at a concentration of greater than or equal to 0.001 mg/L, greater than or equal to 0.01 mg/L, greater than or equal to 0.1 mg/L, greater than or equal to 0.5 mg/L, greater than or equal to 1 mg/L, greater than or equal to 5 mg/L, greater than or equal to 10 mg/L, greater than or equal to 20 mg/L, greater than or equal to 50 mg/L, greater than or equal to 100 mg/L, greater than or equal to 500 mg/L, greater than or equal to 1,000 mg/L, greater than or equal to 5,000 mg/L, greater than or equal to 10,000 mg/L, and/or up to 50,000 mg/L, up to 100,000 mg/L, up to 200,000 mg/L, up to 450,000 mg/L, or more. Combinations of these ranges (e.g., greater than or equal to 0.001 mg/L and less than or equal to 450,000 mg/L, greater than or equal to 1 mg/L and less than or equal to 200,000 mg/L) are possible.

In some embodiments, dissolved magnesium chloride (MgCl₂) is present in the aqueous metal cation impurity-rich source stream. For example, the aqueous metal cation impurity-rich source stream may comprise dissolved magnesium chloride in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, dissolved calcium chloride (CaCl₂) is present in the aqueous metal cation impurity-rich source stream. For example, the aqueous metal cation impurity-rich source stream may comprise dissolved calcium chloride in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, dissolved magnesium sulfate (MgSO₄) is present in the aqueous metal cation impurity-rich source stream. For example, the aqueous metal cation impurity-rich source stream may comprise dissolved magnesium sulfate in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, dissolved calcium sulfate (CaSO₄) is present in the aqueous metal cation impurity-rich source stream. For example, the aqueous metal cation impurity-rich source stream may comprise dissolved calcium sulfate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, a dissolved magnesium borate is present in the aqueous metal cation impurity-rich source stream. For example, the aqueous metal cation impurity-rich source stream may comprise a dissolved magnesium borate in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, a dissolved calcium borate is present in the aqueous metal cation impurity-rich source stream. For example, the aqueous metal cation impurity-rich source stream may comprise a dissolved calcium borate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, a dissolved magnesium phosphate is present in the aqueous metal cation impurity-rich source stream. For example, the aqueous metal cation impurity-rich source stream may comprise a dissolved magnesium phosphate in an amount of greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, a dissolved calcium phosphate is present in the aqueous metal cation impurity-rich source stream. For example, the aqueous metal cation impurity-rich source stream may comprise a dissolved calcium phosphate in an amount of greater than or equal to greater than or equal to 1 mM, greater than or equal to 2 mM, greater than or equal to 5 mM, greater than or equal to 10 mM, greater than or equal to 20 mM, greater than or equal to 50 mM, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

In some embodiments, the aqueous metal cation impurity-rich source stream is free of certain salts or comprises the salts in a relatively low amount. For example, in some embodiments, the aqueous metal cation impurity-rich source stream is free of calcium hydroxide (Ca(OH)₂), or calcium hydroxide is present in the stream (as a solid and/or liquid) in an amount of less than or equal to 5 wt %, less than or equal to 2 wt %, less than or equal to 1 wt %, less than or equal to 0.1 wt %, less than or equal to 0.01 wt %, less than or equal to 0.001 wt %, less than or equal to 0.0001 wt %, less than or equal to 0.00001 wt %, or less.

Other species may be present in the aqueous metal cation impurity-rich source stream. For example, the aqueous metal cation impurity-rich source stream may also comprise alkali metal cations (e.g., sodium cations, potassium cations, cesium cations, and/or rubidium cations). In some embodiments, the aqueous metal cation impurity-rich stream comprises rare earth metal cations (e.g., scandium cations, lanthanum cations, cerium cations, praseodymium cations, neodymium cations, promethium cations, samarium cations, europium cations, gadolinium cations, terbium cations, dysprosium cations, holmium cations, and/or erbium cations). In some embodiments, the aqueous metal cation impurity-rich source steam comprises uranium cations.

The aqueous metal cation impurity-rich source stream may have any of a variety of pH values, depending on the composition of the stream and the configuration of the system. The aqueous metal cation impurity-rich source stream may have a relatively low pH. In some embodiments, the aqueous metal cation impurity-rich source stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous metal cation impurity-rich source stream may have a relatively high pH. In some embodiments, the aqueous metal cation impurity-rich source stream has a pH of greater than or equal to 0, greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

As noted above, in some embodiments, the aqueous metal cation impurity-rich source stream is exposed to a metal cation impurity salt precipitation stream. For example, in FIG. 1A, aqueous metal cation impurity-rich source stream 150 is contacted with metal cation impurity salt precipitation stream 155. The name “metal cation impurity salt precipitation stream” is used for convenience in referring to the stream and its function of inducing precipitation of metal cation impurities, and is not meant to imply that metal cation impurity salts or precipitates thereof are necessarily present in the stream. In some embodiments, the metal cation impurity salt precipitation stream is a homogenous liquid solution. The metal cation impurity salt precipitation stream may be an aqueous solution (e.g., a homogeneous aqueous solution).

The metal cation impurity salt precipitation stream may comprise precipitating agents, such as carbonate anions, that can induce the formation of a solid salt of a metal cation impurity. For example, upon mixture with the aqueous metal cation impurity-rich source stream, the carbonate anions in the metal cation impurity salt precipitation stream may form a precipitate comprising a solid alkaline earth metal carbonate salt. As a specific example, upon mixture with the aqueous metal cation impurity-rich source stream, the carbonate anions in the metal cation impurity salt precipitation stream may precipitate out calcium cations from the aqueous metal cation impurity-rich source stream as solid calcium carbonate (CaCO₃). As another example, upon mixture with the aqueous metal cation impurity-rich source stream, the carbonate anions in the metal cation impurity salt precipitation stream may precipitate strontium cations from the aqueous metal cation impurity-rich source stream as solid strontium carbonate (SrCO₃).

In some embodiments, the metal cation impurity salt precipitation stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, or greater Combinations of these ranges are possible.

In some, but not necessarily all embodiments, the metal cation impurity salt precipitation stream comprises dissolved hydroxide anions at a relatively high concentration. The presence of the hydroxide anions may be due, for example, to incomplete neutralization of hydroxide ions during formation of carbonate anions in the basic-species driven capture of carbon dioxide in the gas-liquid contact vessel. It has been realized in the context of this disclosure that the presence of hydroxide anions in the metal cation impurity salt precipitation stream in addition to the carbonate anions can provide, in some instances, an improved ability to remove some metal cation impurities compared to metal cation impurity salt precipitation streams lacking the hydroxide anions. For example, in instances where magnesium is present as a metal cation impurity, hydroxide ions in the metal cation impurity salt precipitation stream may induce formation of solid magnesium hydroxide (Mg(OH)₂), which has a low water solubility, in addition to (or even instead of) solid magnesium carbonate, which has a comparatively higher water solubility. In some embodiments, the metal cation impurity salt precipitation stream comprises dissolved hydroxide anions at a concentration of greater than or equal to 0.0001 M, greater than or equal to 0.001 M, greater than or equal to 0.01 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges are possible.

The aqueous metal cation impurity-rich source stream may be exposed to the metal cation impurity salt precipitation stream in any of a variety of manners. For example, both streams may be fed into a common conduit (e.g., tube) and mixed accordingly. As another example, the aqueous metal cation impurity-rich source stream and the metal cation impurity salt precipitation stream may be fed to a vessel (e.g., tank) where they may be mixed passively (e.g., by convection) or actively (e.g., by agitation such as stirring). As one example, in FIG. 1A, aqueous metal cation impurity-rich source stream 150 is transported to mixing vessel 157 via first mixing vessel inlet 158, and metal cation impurity salt precipitation stream 155 is transported to mixing vessel 157 via second mixing vessel inlet 159. The aqueous metal cation impurity-rich source stream and the metal cation impurity salt precipitation stream may be mixed in a continuous, batch, or semi-batch manner.

As noted above, the metal cation impurity salt precipitation stream may be formed at least in part by the capture of carbon dioxide (e.g., in a gas-liquid contact vessel), as described in more detail below. For example, in some embodiments, the capture stream described below, which may include dissolved carbonate anions from captured carbon dioxide, may form at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity salt precipitation stream. The embodiment shown in FIG. 1A shows one such way in which the metal cation impurity salt precipitation stream may include captured carbon dioxide, where second inlet 159 of mixing vessel 157 is fluidically connected to contact vessel liquid outlet 133 such that at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of capture stream 108 can be transported from gas-liquid contact vessel 131 to mixing vessel 157 by forming at least a portion of metal cation impurity salt precipitation stream 155.

The exposure of the metal cation impurities to the carbonate anions may cause the formation of the metal cation impurity solids-containing stream. For example, in FIG. 1A, metal cation impurity solids-containing stream 156 is output from mixing vessel 157. The metal cation impurity solids-containing stream may comprise a solid salt comprising at least some (e.g., at least 10 mol %, at least 25 mol %, at least 50 mol %, at least 75 mol %, at least 90 mol %, at least 95 mol %, at least 98 mol %, at least 99 ml %, at least 99.9 mol %, or all) of the at least one of the metal cation impurities from the aqueous metal cation impurity-rich source stream. In some embodiments in which magnesium cations and calcium cations are present as metal cation impurities, the solid salt may comprise, for example, magnesium carbonate and/or calcium carbonate. In some such embodiments, solid magnesium hydroxide may also be formed (e.g., due to the present of hydroxide anions in some embodiments). The salt solid may be formed by precipitation and/or crystallization.

In some embodiments, at least a portion of the solid salt comprising the metal cation impurities is in the form of an amorphous solid (e.g., an amorphous powder). In some embodiments, at least a portion of the solid salt is in the form of a crystalline solid.

The metal cation impurity solids-containing stream may comprise a liquid component (e.g., an aqueous solution) and a solid component, the latter comprising the solid salt comprising the metal cation impurities. At least a portion of the solid component may be suspended in the liquid component. The solid component may be distributed essentially homogeneously throughout the liquid component of the stream or may be at least partially phase-separated. In some embodiments, the metal cation impurity solids-containing stream is a slurry comprising water mixed with the solid salt comprising at least some of the metal cation impurities.

The formation of the solid salt may be associated with the removal of a relatively high percentage of dissolved metal cation impurities from the liquid solution phase. This may advantageously permit the resulting liquid solution phase (e.g., the liquid component of the metal cation impurity solids-containing stream) to be used in applications for which dissolved metal cation impurities are undesirable (e.g., where scaling is undesirable).

In some embodiments, the ratio of the molar concentration of at least one dissolved metal cation impurity in the aqueous metal cation impurity-rich source stream to the molar concentration of the dissolved metal cation impurity in the metal cation impurity solids-containing stream (that is the concentration corresponding solely to the dissolved form of the metal cation impurity and not including any solid form of the metal cation impurity in the stream) is greater than or equal to 2, greater than or equal to 3, greater than or equal to 5, greater than or equal to 10, greater than or equal to 20, greater than or equal to 50, greater than or equal to 100, greater than or equal to 200, greater than or equal to 500, greater than or equal to 1000, and/or up to 2000, up to 5000, up to 10,000, up to 100,000, up to 1,000,000, or more. As a purely illustrative example, in an instance where the aqueous metal cation impurity-rich stream comprises dissolved metal cation impurities in the form of 100 mg/L calcium cations and 100 mg/L magnesium cations and the resulting metal cation impurity solids-containing stream comprises dissolved calcium cations at a concentration of 50 mg/L and 80 mg/L, then the above-mentioned ranges for ratios are satisfied because the ratio of the concentration of calcium cations in the aqueous metal cation impurity-rich source stream to the concentration of calcium cations in the metal cation impurity solids-containing stream is 2 (thereby satisfying a ratio of at least 2), even though the ratio of the concentration of magnesium cations in the aqueous metal cation impurity-rich source stream to the concentration of magnesium cations in the metal cation impurity solids-containing stream is 1.25 (which does not satisfy any of the ranges above). That is because at least one of the metal cation impurities (calcium cations) satisfies the ratio ranges.

In some embodiments, the ratio of the total molar concentration of dissolved metal cation impurities in the aqueous metal cation impurity-rich source stream to the total molar concentration of dissolved metal cation impurities in the metal cation impurity solids-containing stream is greater than or equal to 2, greater than or equal to 3, greater than or equal to 5, greater than or equal to 10, greater than or equal to 20, greater than or equal to 50, greater than or equal to 100, greater than or equal to 200, greater than or equal to 500, greater than or equal to 1000, and/or up to 2000, up to 5000, up to 10,000, up to 100,000, up to 1,000,000, or more.

In some embodiments, at least a portion of the solid salt is separated from the metal cation impurity solids-containing stream. For example, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity solids-containing stream may be transported to a solid separation vessel. The solids separation vessel may receive the metal cation impurity solids-containing stream via an inlet (e.g., fluidically connected to an outlet of the mixing vessel) and provide a location that permits the separation (e.g., active separation or passive separation) of solids from liquids. For example, in FIG. 1B, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of metal cation impurity solids-containing stream 156 may be transported to solids separation vessel 160 via inlet 161 fluidically connected to outlet 162 of mixing vessel 157.

In the solids separation vessel, at least a portion of the solid salt comprising the metal cation impurities may be removed to form a metal cation impurity-lean liquid stream. For example, metal cation impurity-lean liquid stream 163 may be output from solids separation vessel 160.

In some embodiments, the solids separation vessel is a gravity-based settling vessel. In some embodiments, the gravity-based settling device comprises a clarifier. In some embodiments, the clarifier is a lamella clarifier. A lamella clarifier generally refers to a vessel comprising a plurality of inclined plates. In operation, a stream may enter the lamella clarifier, and solids within the stream may settle on one or more of the inclined plates of the lamella clarifier.

The solids separation vessel need not necessarily be a clarifier, and may be any of a variety of other type of solids separation vessel known in the art. For example, the solids separation vessel may comprise a hydrocyclone, a corrugated plate interceptor, an adsorption media filter, a coalescing media filter, a membrane filter, an induced gas flotation (IGF) separator, a dewatering filter press, a centrifuge, and/or a skimmer.

In some embodiments, at least some of the metal cation impurity solids-containing stream is treated with one or more reagents to promote effective solid-liquid separation. The metal cation impurity solids-containing stream may be exposed to the reagent before and/or during transportation of the metal cation impurity solids-containing stream to the solids separation vessel. In some embodiments, the reagent comprises a coagulant and/or flocculant. Examples of coagulants and/or flocculants include, but are not limited to, inorganic species (e.g., aluminum sulfate, aluminum chloride, aluminum chlorohydrate, ferric chloride, and/or ferric sulfate) and/or organic species (e.g., polymers such as polyacrylamide, polyacrylates, polyoxyethylene, polyvinylamine, and/or polyvinyl sulfate).

In some, but not necessarily all embodiments, little to none of the metal cation impurity solids-containing stream or a component thereof (e.g., solid salt of the metal cation impurity) is recycled back to an earlier process in the overall method or system. This stands in contrast to techniques that use recycling of such a solids-containing stream, for example to regenerate species such as Ca(OH)₂ for use earlier in the method or system. Such a recycling may not be desired in some embodiments, such as those in which the solid salt of the metal cation impurity itself is desired as a product (e.g., to be collected and/or discharged from the system). In some embodiments, none or less than or equal to 5 wt %, less than or equal to 2 wt %, less than or equal to 1 wt %, less than or equal to 0.1 wt %, less than or equal to 0.01 wt %, less than or equal to 0.001 wt %, less than or equal to 0.0001 wt %, less than or equal to 0.00001 wt %, or less of the metal cation impurity solids-containing stream (or a component thereof) is recycled back to an earlier process. For example, in some embodiments, the aqueous metal cation impurity-rich source stream does not comprise any of the metal cation impurity solids-containing stream (or a component thereof) or less than or equal to 5 wt %, less than or equal to 2 wt %, less than or equal to 1 wt %, less than or equal to 0.1 wt %, less than or equal to 0.01 wt %, less than or equal to 0.001 wt %, less than or equal to 0.0001 wt %, less than or equal to 0.00001 wt %, or less of the metal cation impurity solids-containing stream (or a component thereof) is incorporated into the aqueous metal cation impurity-rich source stream.

In some, but not necessarily all embodiments, little to none of the metal cation impurity-lean liquid stream is recycled back to an earlier process in the overall method or system. In some embodiments, none or less than or equal to 5 wt %, less than or equal to 2 wt %, less than or equal to 1 wt %, less than or equal to 0.1 wt %, less than or equal to 0.01 wt %, less than or equal to 0.001 wt %, less than or equal to 0.0001 wt %, less than or equal to 0.00001 wt %, or less of the metal cation impurity-lean liquid stream is recycled back to an earlier process. For example, in some embodiments, the aqueous metal cation impurity-rich source stream does not comprise any of the metal cation impurity-lean liquid stream or less than or equal to 5 wt %, less than or equal to 2 wt %, less than or equal to 1 wt %, less than or equal to 0.1 wt %, less than or equal to 0.01 wt %, less than or equal to 0.001 wt %, less than or equal to 0.0001 wt %, less than or equal to 0.00001 wt %, or less of the metal cation impurity-lean liquid stream is incorporated into the aqueous metal cation impurity-rich source stream.

The carbon dioxide may be captured via one or more acid-base equilibrium reactions to form carbonate anions. Generally, these processes include exposure of carbon dioxide to a liquid solution comprising basic species. Examples of such basic species are described in more detail below. In some, but not necessarily all embodiments, at least some of the basic species are electrogenerated (e.g., directly or indirectly). Electrical generation of basic species (e.g., hydroxide ions) may advantageously involve inexpensive and/or environmentally friendly reagents and/or relatively low energetic inputs. However, in some embodiments, at least some of the basic species are provided without use of an electrochemical process. For example, the basic species may be provided as chemical reagents acquired separately (e.g., commercially) and/or generated from one or more other processes (e.g., chemical processes performing thermal rather than electrochemical reactions).

In some embodiments, at least some of the basic species are electrogenerated in an electrolytic cell. Further details of examples of embodiments involving electrolytic generation of the basic species (e.g., hydroxide ions) are described in more detail below.

As noted above, the basic species may be exposed to carbon dioxide from an input gas stream in a gas-liquid contact vessel. This exposure may result in the capture of the carbon dioxide and, in some instances, formation of a carbon dioxide-lean output gas stream and a capture stream comprising carbonate anions formed from the captured carbon dioxide. The capture stream may further comprise hydroxide anions, such as hydroxide ions not neutralized during the conversion of carbon dioxide to carbonate (e.g., due to stoichiometric excess or thermodynamic/kinetic factors). The capture stream may form some or all of the metal cation impurity salt precipitation stream, as discussed above.

In some embodiments, carbon dioxide from an input gas stream is captured. The capture of the carbon dioxide may be induced by exposure of the carbon dioxide to a relatively high pH solution (e.g., due to the presence of the basic species). In some embodiments, at least some (e.g., at least 5 mol %, at least 10 mol %, at least 25 mol %, at least 50 mol %, at least 75 mol %, at least 90 mol %, at least 95 mol %, at least 98 mol %, at least 99 mol %, or more) of the basic species (e.g., electrogenerated basic species) from a base-rich product solution are exposed to carbon dioxide from the input gas stream. As an example, in FIG. 1A, contact vessel liquid inlet stream 106 comprising basic species and input gas stream 105 are each input into gas-liquid contact vessel 131, where the presence of the basic species, via one or more acid-base equilibrium reactions, the removal of carbon dioxide from input gas stream 105 to form the carbon dioxide-lean output gas stream 107 and capture stream 108.

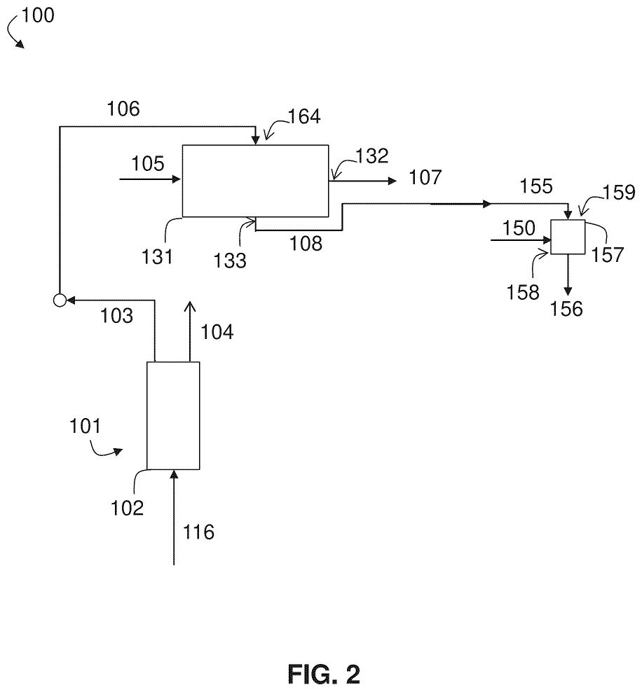

As yet another example, in FIG. 2, contact vessel liquid inlet stream 106 comprising at least a portion (e.g., at least 5 mol %, at least 10 mol %, at least 25 mol %, at least 50 mol %, at least 75 mol %, at least 90 mol %, at least 95 mol %, at least 98 mol %, at least 99 mol %, or more) of base-rich product solution 103 and input gas stream 105 are each input into gas-liquid contact vessel 131, where the presence of the electrogenerated basic species induces, via one or more acid-base equilibrium reactions, the removal of carbon dioxide from input gas stream 105 to form the carbon dioxide-lean output gas stream 107 and capture stream 108.

The acid-base equilibria driving removal of carbon dioxide via exposure of carbon dioxide to the basic species may proceed as follows:

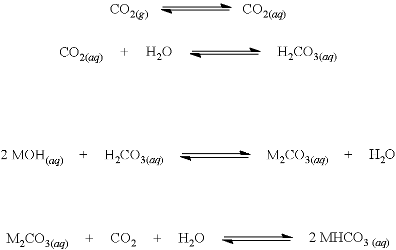

where MOH corresponds to dissolved cation and hydroxide. Here, the hydroxide drives deprotonation of carbonic acid to form carbonate ions thereby converting carbon dioxide from a gas to a dissolved species in a liquid solution. It should be understood that while the chemical reactions shown above include double arrows for equilibrium reactions and are referred to in various places of this disclosure as acid-base equilibria, the methods described in this disclosure may be operated under conditions such that some or all of these reactions proceed without reaching chemical equilibrium (e.g., due to mass transfer of species between different phases).

Any of a variety of gas streams may be employed as the input gas stream. In some embodiments, the input gas stream is or is derived from air (e.g., ambient air). In such a way, the methods and systems of this disclosure may be used to perform direct air capture of carbon dioxide. In some embodiments, the input gas is from a point source of carbon dioxide (e.g., industrial effluent). The point source of carbon dioxide may be a single location (e.g., a power plant, factory, and/or industrial facility) that emits carbon dioxide, as opposed to diffuse, atmospheric carbon dioxide present in ambient air. For example, the input gas stream may comprise or be derived from flue gas. In such a way, the methods and systems of this disclosure may be used to perform direct carbon capture. In some embodiments, the point source comprises a power plant, a cement production facility, a steel production facility, an aluminum production facility, a steam methane reforming facility, an autothermal reforming facility, a natural gas wellhead, a natural gas pipeline, a paper mill, and/or a Haber-Bosch facility (which catalytically produces NH₃ from H₂ and N₂). While the input gas stream may be referred to as a stream, this is not to imply any particular flow rate or type of flow path for the stream. For example, the system may intake gas (e.g., ambient air) surrounding the system, and/or or gas may be flowed (e.g., at ambient or an elevated pressure) through a conduit into, for example, the gas-liquid contact vessel.

In some embodiments, the input gas stream comprises carbon dioxide in an amount of less than or equal to 200,000 ppm. In some embodiments, the input gas stream comprises carbon dioxide in an amount of less than or equal to 100,000 ppm, less than or equal to 50,000 ppm, less than or equal to less than or equal to 20,000 ppm, less than or equal to 10,000 ppm, less than or equal to 5,000 ppm, less than or equal to 1,000 ppm, less than or equal to 600 ppm, less than or equal to 500 ppm, and/or as low as 400 ppm, as low as 300 ppm, as low as 100 ppm, or less by volume. Combinations of these ranges (e.g., less than or equal to 100,000 ppm and as low as 100 ppm, or less than or equal to 1,000 ppm and as low as 100 ppm) are possible.

In some embodiments (e.g., where the method is performed using direct air capture), the input gas stream comprises carbon dioxide at a partial pressure of less than or equal to 0.5 bar, less than or equal to 0.2 bar, less than or equal to 0.1 bar, less than or equal to 0.05 bar, less than or equal to 0.02 bar, less than or equal to 0.01 bar, less than or equal to 0.005 bar, less than or equal to 0.002 bar, less than or equal to 0.001 bar, and/or as low as 0.0005 bar, as low as 0.0002 bar, as low as 0.0001 bar, or less. Combinations of these ranges (e.g., less than or equal to 0.5 bar and as low as 0.0001 bar) are possible. In some embodiments (e.g., where the method is performed for using point source carbon capture), the input gas stream comprises carbon dioxide at a partial pressure of greater than or equal to 0.002 bar, greater than or equal to 0.005 bar, greater than or equal to 0.01 bar, greater than or equal to 0.02 bar, greater than or equal to 0.05 bar, greater than or equal to 0.1 bar, greater than or equal to 0.2 bar, greater than or equal to 0.5 bar, greater than or equal to 1 bar, greater than or equal to 2 bar, greater than or equal to 5 bar, greater than or equal to 10 bar, and/or up to 20 bar, up to 30 bar, up to 40 bar, or more. Combinations of these ranges (e.g., greater than or equal to 0.002 bar and less than or equal to 40 bar) are possible.

As noted above, the interaction between the carbon dioxide and the basic species (e.g., via one or more acid-base equilibrium reactions) may produce a carbon dioxide-lean output gas stream. For example, in FIG. 1A, carbon dioxide-lean output gas stream 107 may be output from contact vessel gas outlet 132 of gas-liquid contact vessel 131. The carbon dioxide-lean gas outlet stream may have a relatively low concentration of carbon dioxide, which may be desirable (e.g., in applications in which carbon dioxide removal is desirable, ranging from purifying air in enclosed places to reducing carbon dioxide output of industrial processes to reducing atmospheric carbon dioxide). In some embodiments, the carbon dioxide-lean output gas stream comprises carbon dioxide in an amount of less than or equal to 50,000 ppm, less than or equal to 25,000 ppm, less than or equal to 20,000 ppm, less than or equal to 10,000 ppm, less than or equal to 5,000 ppm, less than or equal to 1,000 ppm, less than or equal to 600 ppm, less than or equal to 500 ppm, less than or equal to 400 ppm, less than or equal to 300 ppm, less than or equal to 200 ppm, less than or equal to 100 ppm, less than or equal to 50 ppm, less than or equal to 20 ppm, less than or equal to 10 ppm, less than or equal to 5 ppm, less than or equal to 1 ppm, and/or as low as 0.5 ppm, as low as 0.1 ppm, as low as 0.01 ppm, or less by volume. Combinations of these ranges (e.g., greater than or equal to 0.01 ppm and less than or equal to 50,000 ppm, or greater than or equal to 1 ppm and less than or equal to 25,000 ppm) are possible.

The carbon dioxide-lean output gas stream may have a lower concentration of carbon dioxide than the input gas stream. In some embodiments, a relatively high percentage of carbon dioxide in the input gas stream is removed in forming the carbon dioxide-lean output gas stream. For example, in some embodiments, a molar ratio of the concentration of carbon dioxide in the input gas stream to the concentration of carbon dioxide in the carbon dioxide-lean output gas stream is at least 1.1, at least 1.3, at least 1.5, at least 2, at least 2.5, at least 5, at least 10, and/or up to 20, up to 50, up to 100, up to 1000, up to 10,000, up to 100,000, up to 1,000,000, up to 5,000,000, or more. Combinations of these ranges (e.g., at least 1.1 and less than or equal to 5,000,000, or at least 1.3 and less than or equal to 100) are possible.

In some embodiments, the carbon dioxide-lean output gas stream is discharged from the system. However, in other embodiments, the carbon dioxide-lean output gas stream is transported to a different component of the system for further treatment (e.g., removal of additional contaminants and/or combination with other streams).

In some embodiments, the interaction between the carbon dioxide and the basic species (e.g., via one or more acid-base equilibrium reactions) produces a capture stream. For example, in FIG. 1A, capture stream 108 may be output from contact vessel liquid outlet 133 of gas-liquid contact vessel 131. The capture stream may comprise captured carbon dioxide in the form of, for example, dissolved carbonate anions formed from carbon dioxide (e.g., upon exposure to electrogenerated alkalinity in the form of basic species). The capture stream may have a relatively high concentration of dissolved carbonate anions. For example, in some embodiments, the capture stream comprises dissolved carbonate anions at a concentration of greater than or equal to 0.1 M, greater than or equal to 0.2 M, greater than or equal to 0.5 M, greater than or equal to 1 M, and/or up to 1.5 M, up to 2 M, up to 3 M, up to 5 M or greater. Combinations of these ranges (greater than or equal to 0.1 M and less than or equal to 5 M, or greater than or equal to 0.5 M and less than or equal to 2 M) are possible. In some, but not necessarily all embodiments, the base-rich product solution is free of carbonate anions while the capture stream comprises carbonate anions. In some embodiments in which the base-rich product solution comprises carbonate anions, the molar ratio of the concentration of carbonate anions in the capture stream to the concentration of carbonate anions in the stream to which the carbon dioxide is exposed (e.g., the contact vessel liquid inlet stream, which may be formed from at least a portion of the base-rich product solution) is at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

The capture stream may have a relatively high concentration of dissolved hydroxide anions. The hydroxide anions may be residual hydroxide anions not neutralized during conversion of carbon dioxide to carbonate anions. In some embodiments, the capture stream comprises dissolved hydroxide anions at a concentration of greater than or equal to 0.0001 M, greater than or equal to 0.001 M, greater than or equal to 0.01 M, greater than or equal to 0.1 M, greater than or equal to 0.2 M, greater than or equal to 0.5 M, greater than or equal to 1 M. and/or up to 1.5 M, up to 2 M, up to 3 M, or greater. Combinations of these ranges (greater than or equal to 0.0001 M and less than or equal to 3 M) are possible. In some embodiments, the molar ratio of the concentration of hydroxide anions in the stream to which the carbon dioxide is exposed (e.g., the contact vessel liquid inlet stream, which may be formed from at least a portion of the base-rich product solution) to the concentration of hydroxide anions in the capture stream is at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges are possible.

In some embodiments, capture stream has a relatively high pH. For example, in some embodiments, the capture stream has a pH of greater than or equal to 7, greater than or equal to 8, greater than or equal to 9, greater than or equal to 10, greater than or equal to 11, greater than or equal to 12, and/or up to 13, up to 14, or greater. Combinations of these ranges are possible.

In some embodiments, the capture stream comprises at least some of non-proton cations (e.g., the metal cations and/or ammonium cations discussed below). The cations may be from a base-rich product solution (e.g., from an electrolytic process, as described below). For example, the cations in the capture stream may constitute at least a portion (e.g., at least 25 mol %, at least 50 mol %, at least 75 mol %, at least 90 mol %, at least 95 mol %, at least 98 mol %, at least 99 mol %, or more) of the cations in the base-rich product solution. For example, a contact vessel inlet stream comprising dissolved MOH (e.g., NaOH) may be transported to the contact vessel, and a capture stream comprising dissolved M₂CO₃ (e.g., Na₂CO₃) may be produced by the contact vessel upon interaction (e.g., contacting and/or mixing) with the input gas stream.

In some embodiments, at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the capture stream is transported out of the gas-liquid contact vessel. For example, in FIG. 1A, capture stream 108 is transported out of contact vessel liquid outlet 133 of gas-liquid contact vessel 131. In some embodiments, the capture stream transported out of the contact vessel forms at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the metal cation impurity salt precipitation stream.

In some embodiments, the basic species (e.g., electrogenerated basic species or non-electrogenerated basic species) and the carbon dioxide from the input gas stream are exposed to each other in a gas-liquid contact vessel. For example, in FIG. 1A, gas-liquid contact vessel 131 receives (a) input gas stream 105 comprising carbon dioxide and (b) contact vessel liquid inlet stream 106, which comprises at least a portion of base-rich product solution 103 comprising basic species, such that the basic species can interact with the carbon dioxide as described above. In some embodiments in which the basic species is electrogenerated, at least a portion of the base-rich product solution is transported from an electrolysis assembly (described below) to the contact vessel by forming at least a portion of the contact vessel liquid inlet stream (e.g., via a fluidic connection between the first electrolysis assembly liquid outlet and the contact vessel liquid inlet). The input gas stream may be transported to the contact vessel via the contact vessel gas inlet. In some embodiments, the gas-liquid contact vessel is separate from the electrolysis assembly (e.g., separate from the electrolytic cell). This may permit the interaction between the carbon dioxide and the electrogenerated basic species to occur in a location separate from the electrolysis assembly (e.g., after expulsion of basic species from the electrolysis assembly).

Any of a variety of gas-liquid contact vessels may be employed. The gas-liquid contact vessel may comprise a gas-liquid contactor configured to promote mass and in some instances heat transfer between gas-phase species and liquid-phase species. In some embodiments, the contact vessel comprises a differential gas-liquid contactor. In other embodiments, the contact vessel comprises a stepwise gas-liquid contactor. Examples of types of gas-liquid contact vessels include, but are not limited to bubble columns, spray towers, cooling towers, packed columns, agitated vessels, plate columns, rotating disc contactors, Venturi tubes, hollow fiber gas-liquid contactors. In some embodiments, the gas-liquid contact vessel comprises an interior volume in fluid communication with the gas inlet and the liquid inlet. The interior volume may permit contact between the input gas stream and the contact vessel inlet liquid stream. Contact between carbon dioxide from the input gas stream and liquid from the inlet liquid stream may result in the dissolution of at least some of the gaseous carbon dioxide. The dissolved carbon dioxide may then undergo the acid-base equilibria described above.

Electrolytic generation of the basic species may be performed in any of a variety of ways and using any of a variety of system configurations and chemistries. Non-limiting illustrative examples of electrolytic techniques for basic species (e.g., hydroxide ion) generation are now described. In some embodiments, an aqueous input stream is transported to an electrolytic cell. The electrolytic cell may be part of an electrolysis assembly. For example, in FIG. 2 aqueous input stream 116 is transported to an inlet of electrolysis assembly 101, which may include electrolytic cell 102, as discussed below. The aqueous input stream may be sourced and/or derived from any of a variety of streams, such as a brine, industrial effluent, streams from salt flats, streams rich in alkaline and/or alkali minerals (e.g., containing sulfides, sulfates, phosphates, nitrates, and/or chlorides), seawater, and/or wastewater. However, in some embodiments, the aqueous input stream is formulated for the purpose of generating base-rich and/or acid-rich product solutions at least some of which may be suitable for participating in capture and/or release of carbon dioxide.

The aqueous input stream may comprise liquid water in an amount of greater than or equal to 40 weight percent (wt %), greater than or equal to 50 wt %, greater than or equal to 75 wt %, greater than or equal to 90 wt %, greater than or equal to 95 wt %, greater than or equal to 98 wt %, greater than or equal to 99 wt %, greater than or equal to 99.9 wt %, or more by weight of liquid in the aqueous input stream.

The aqueous input stream may include a relatively high concentration of dissolved salt. The salt may promote relatively high conductivity within the electrolytic cell (e.g., by promoting charge neutrality as electrochemical reactions occur at and/or near electrode surfaces). Alternatively or additionally, the salt may promote high conductivity within the electrolytic cell by promoting charge transport (e.g., by promoting ion transport).

In some embodiments, the aqueous input stream comprises dissolved cations. Any of a variety of cations may be present. The cations may comprise monovalent cations (carrying a single positive charge). In some embodiments, the cations comprise metal cations. For example, the metal cations may comprises alkali metal ions. As a more specific example, the metal cations comprise sodium ions (Na⁺), and/or potassium ions (K⁺). In some embodiments, the cations comprise ammonium cations (e.g., NH₄⁺ or a derivative thereof such as an alkylammonium). In some embodiments, the metal cations are spectator ions with respect to the chemistries employed by the electrolysis assembly and/or other reactions performed in the methods and systems of this disclosure.

In some embodiments, some (e.g., at least 0.3 mol %, at least 1 mol %, at least 10 mol %, at least 20 mol %, at least 50 mol %, at least 75 mol %, at least 95 mol %, at least 98 mol %, at least 99 mol %) or all of the cations are alkali metal ions.

In some embodiments, some (e.g., at least 0.3 mol %, at least 1 mol %, at least 10 mol %, at least 20 mol %, at least 50 mol %, at least 75 mol %, at least 95 mol %, at least 98 mol %, at least 99 mol %) or all of the cations are sodium ions and/or potassium ions.

In some embodiments, some (e.g., at least 0.3 mol %, at least 1 mol %, at least 10 mol %, at least 20 mol %, at least 50 mol %, at least 75 mol %, at least 95 mol %, at least 98 mol %, at least 99 mol %) or all of the cations are sodium ions.

In some embodiments, some (e.g., at least 0.3 mol %, at least 1 mol %, at least 10 mol %, at least 20 mol %, at least 50 mol %, at least 75 mol %, at least 95 mol %, at least 98 mol %, at least 99 mol %) or all of the cations are potassium ions.

As noted above, the cations may be present in the aqueous input stream at a relatively high concentration. In some embodiments, the dissolved cations are present in the aqueous input stream at a concentration of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, up to 8 M, up to 10 M, up to 20 M, or greater. Combinations of these ranges (e.g., greater than or equal to 0.1 M and up to 20 M, greater than or equal to 0.1 M and up to 8 M, greater than or equal to 0.1 M and up to 6 M, greater than or equal to 1 M and up to 6 M) are possible. It has been observed that, in some embodiments, a concentration of the cations of greater than or equal to 1 M and less than or equal to 6 M can contribute to desirable conductivity when operating the electrochemical cell.

In some embodiments, the aqueous input stream comprises dissolved anions. Any of a variety of anions may be present. In some embodiments, at least some of the anions are non-hydroxide anions. The anions may comprise monovalent anions (carrying a single negative charge). For example, the anions may comprise halide ions. As a more specific example, the anions may comprise chloride ions (Cl⁻), bromide ions (Br⁻), and/or iodide ions (I⁻). Other examples of monovalent anions include, but are not limited to, nitrates. In some embodiments, the monovalent anions comprise nitrites. In some embodiments, the monovalent anions comprise perchlorates. In some embodiments, the monovalent anions comprise hydrogen sulfate ions (HSO₄⁻). In some embodiments, the anions comprise oxyanions. In some embodiments, the anions comprise divalent ions (carrying a charge of −2). For example, the anions may comprise sulfate ions (SO₄²⁻). In some embodiments, the anions comprise phosphate ions (e.g., orthophosphate ions (PO₄³⁻), monohydrogen phosphate ions (HPO₄²⁻), and/or dihydrogen phosphate ions (H₂PO₄⁻)). In some embodiments, the anions comprise borate ions (e.g., orthoborate ions (BO₃³⁻), tetrahydroxyborates (B(OH)₄⁻), tetraborates (B₄O₇²⁻), and/or polyborates). In some embodiments, the anions include the conjugate base of an organic acid (e.g., a carboxylate-containing organic compound). Examples of conjugate bases of organic acids include, but are not limited to, formate, acetate, lactate, oxalate, and/or citrate. Another example of an organic acid is benzoic acid. In some embodiments, the anions referenced here do not include carbonate ions and/or bicarbonate ions (though one or both of carbonate anions and bicarbonate anions may also be present in the aqueous input stream in some embodiments). In some embodiments, the anions are conjugate bases of strong acids. In some embodiments, the anions (e.g., non-hydroxide anions) are conjugate bases of weak acids. In some embodiments, the anions are spectator ions with respect to the chemistries employed by the electrolysis assembly and/or other reactions performed in the methods and systems of this disclosure.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are non-hydroxide anions.

In some embodiments, some (e.g., at least 1 mole percent (mol %), at least 10 mol %, at least 20 mol %, at least 50 mol %, at least 75 mol %, at least 95 mol %, at least 98 mol %, at least 99 mol %) or all of the anions are chloride ions.

In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are phosphate ions (e.g., monohydrogen phosphate ions, dihydrogen phosphate ions, and/or dihydrogen phosphate ions). In some embodiments, some (e.g., at least 1 mol %, at least 10 mol %, at least 20 mol %, at least 50 mol %, at least 75 mol %, at least 95 mol %, at least 98 mol %, at least 99 mol %) or all of the anions are dihydrogen phosphate ions.

As noted above, the anions may be present in the aqueous input stream in a relatively high concentration. In some embodiments, the dissolved anions are present in the aqueous input stream at a concentration of greater than or equal to 0.1 moles per liter (M), greater than or equal to 0.3 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6, M, up to 7 M, up to 8 M, up to 10 M, up to 20 M, or greater. Combinations of these ranges (e.g., greater than or equal to 0.1 M and up to 20 M, greater than or equal to 0.1 M and up to 10 M, greater than or equal to 0.3 M and up to 6 M) are possible.

In some embodiments, a dissolved alkali metal chloride is present in the aqueous input stream. For example, the aqueous input stream may comprise a dissolved alkali metal chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, up to 20 M, or greater. Combinations of these ranges are possible.

In some embodiments, dissolved sodium chloride is present in the aqueous input stream. For example, the aqueous input stream may comprise dissolved sodium chloride in an amount of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 7 M, or greater. Combinations of these ranges (e.g., greater than or equal to 0.1 M and less than or equal to 7 M, greater than or equal to 1 M and less than or equal to 6 M) are possible.

In some embodiments, dissolved potassium chloride is present in the aqueous input stream. For example, the aqueous input stream may comprise dissolved potassium chloride in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 6 M, up to 8 M. or greater. Combinations of these ranges (e.g., greater than or equal to 0.1 M and less than or equal to 8 M, greater than or equal to 1 M and less than or equal to 5 M) are possible.

In some embodiments, a dissolved alkali orthophosphate (e.g., potassium orthophosphate and/or sodium orthophosphate) is present in the aqueous input stream. For example, the aqueous input stream may comprise dissolved alkali orthophosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible. In some embodiments, a dissolved alkali monohydrogen phosphate (e.g., potassium monohydrogen phosphate and/or sodium monohydrogen phosphate) is present in the aqueous input stream. For example, the aqueous input stream may comprise dissolved alkali monohydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M. or greater. Combinations of these ranges (e.g., greater than or equal to 0.1 M and less than or equal to 10 M, greater than or equal to 0.3 M and less than or equal to 6 M) are possible. In some embodiments, a dissolved alkali dihydrogen phosphate (e.g., potassium dihydrogen phosphate and/or sodium dihydrogen phosphate) is present in the aqueous input stream. For example, the aqueous input stream may comprise dissolved alkali dihydrogen phosphate in an amount of greater than or equal to 0.1 moles per liter (M), greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, greater than or equal to 0.3 M and less than or equal to 6 M) are possible.

In some embodiments, dissolved carbonate anions are present in the aqueous input stream in addition to the other anions discussed above. For example, the aqueous input stream may comprise dissolved carbonate anions in an amount of greater than or equal to 0.005 M, greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

In some embodiments, dissolved bicarbonate anions are present in the aqueous input stream in addition to the other anions discussed above. For example, the aqueous input stream may comprise dissolved bicarbonate anions in an amount of greater than or equal to 0.01 M, greater than or equal to 0.02 M, greater than or equal to 0.05 M, greater than or equal to 0.1 moles per liter (M), greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.005 M and less than or equal to 3 M, greater than or equal to 0.05 M and less than or equal to 2 M) are possible.

The aqueous input stream may have any of a variety of pH values, depending on the composition of the stream and the configuration of the system. The aqueous input stream may have a relatively low pH (e.g., in instances where acid (electrogenerated or otherwise) is present). In some embodiments, the aqueous input stream has a pH of less than or equal to 14, less than or equal to 12, less than or equal to 10, less than or equal to 8, less than or equal to 7, less than or equal to 6, less than or equal to 5, less than or equal to 4, less than or equal to 3, less than or equal to 2, or less. The aqueous input stream may have a relatively high pH (e.g., in instances where base (electrogenerated or otherwise) is present). In some embodiments, the aqueous input stream has a pH of greater than or equal to 1, greater than or equal to 3, greater than or equal to 5, greater than or equal to 7, greater than or equal to 8, greater than or equal to 9, greater than or equal to 10, greater than or equal to 11, greater than or equal to 12, or greater. Combinations of these ranges are possible.

The electrolysis assembly may have any of a variety of configurations, depending on, for example, the arrangement of the overall system and/or the desired electrochemistries to be employed in electrogenerating basic and/or acidic species. Upon transport to the electrolysis assembly, one or more components of the aqueous input stream (e.g., dissolved species and/or solvent molecules such as water molecules) may undergo one or more electrochemically-induced reactions. The reactions may result, directly or indirectly, in the production of an acidic species and/or basic species. The acidic species and/or basic species may promote downstream capture and/or release of carbon dioxide.

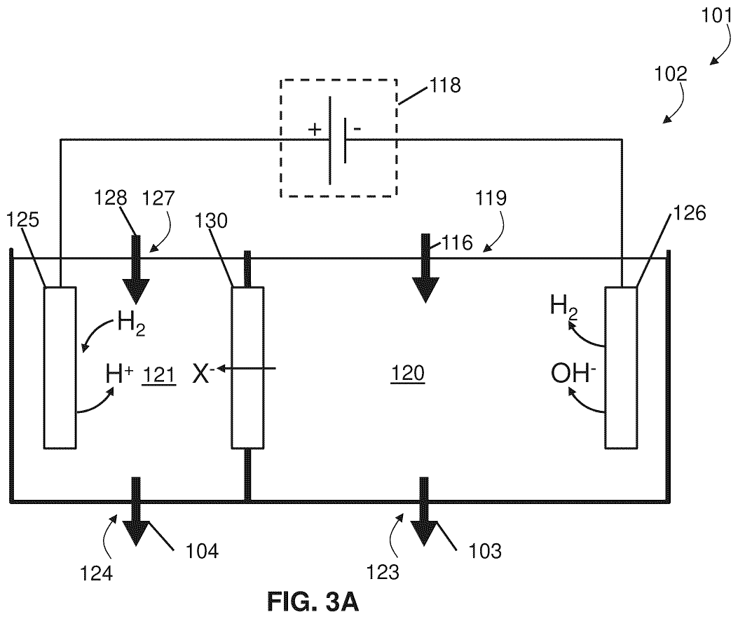

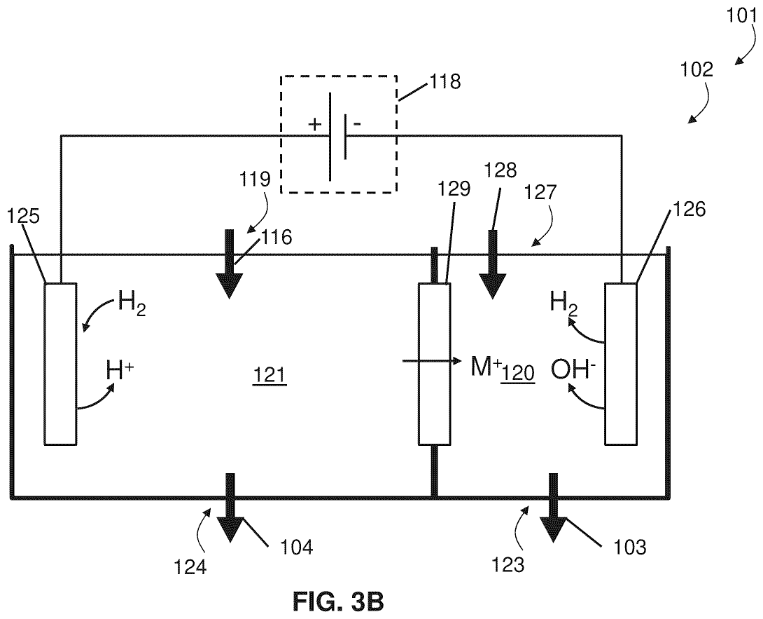

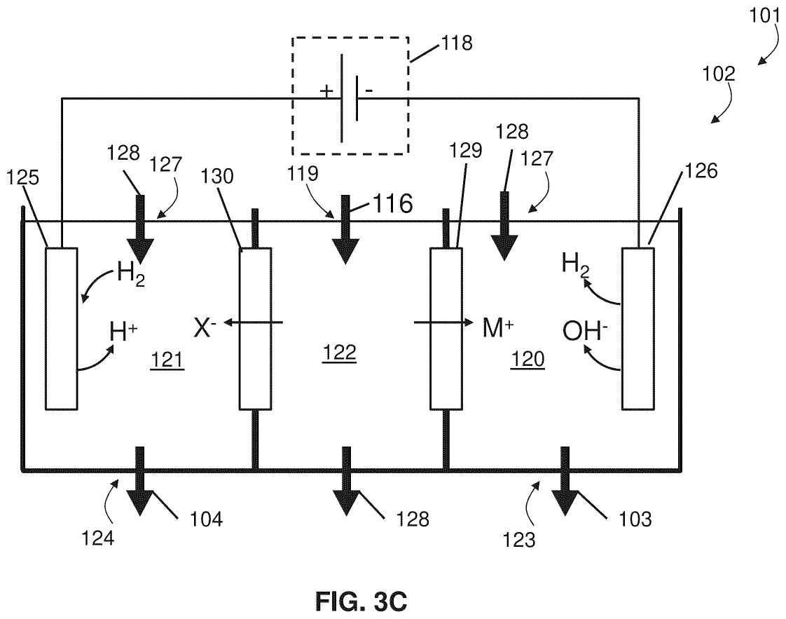

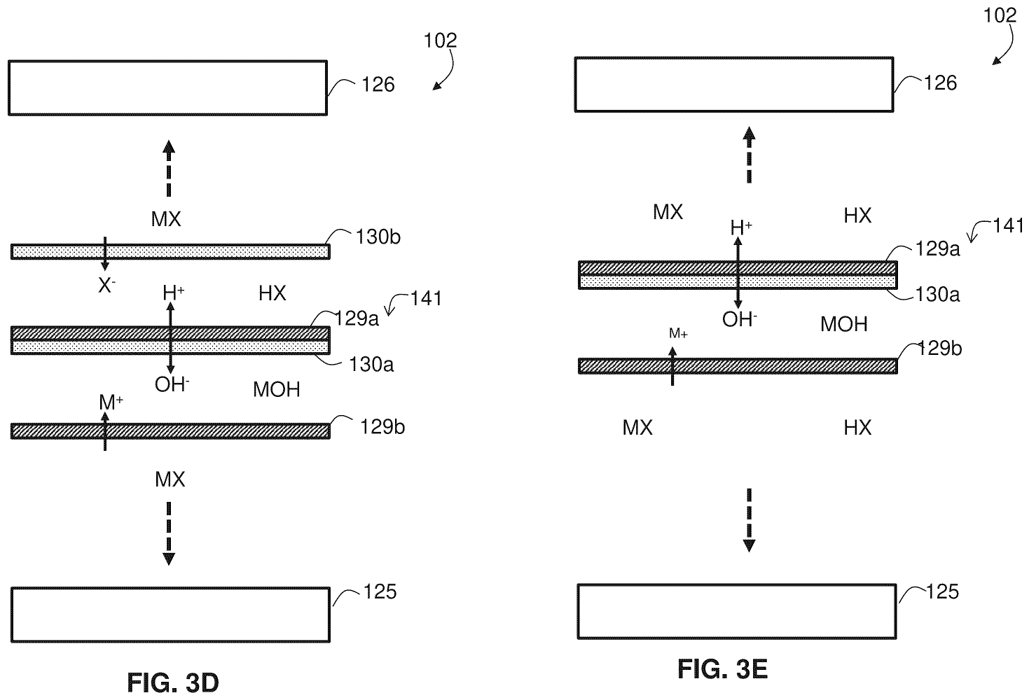

In some embodiments, the electrolysis assembly includes an electrolytic cell. FIGS. 3A-3C show cross-sectional schematic illustrations of non-limiting examples of embodiments of electrolysis assemblies 101 comprising electrolytic cell 102. An electrolytic cell generally comprises an anode and a cathode and is configured to use electrical energy to drive a chemical reaction that is thermodynamically non-spontaneous under the conditions of the reaction (e.g., temperature and pressure). The electrolytic cell may be a flow cell. The flow cell may be configured to receive one or more liquid streams (e.g., comprising reagents and/or electrolyte components). The flow cell may be configured to output one or more product streams comprising an electrogenerated product.

The embodiments in FIGS. 3A-3C use the hydrogen evolution and hydrogen reduction reactions as illustrative half reactions that can be employed in an overall chemical reaction that can be performed in the electrolytic cell. However, other chemistries (e.g., chloralkali chemistries) can also be employed.

While the electrolysis assemblies shown in FIGS. 3A-3C have a single electrolytic cell, some electrolysis assemblies may include multiple electrolytic cells (e.g., at least 2 cells, at least 3 cells, at least 4 cells, at least 5 cells, at least 10 cells, at least 50 cells, at least 100 cells, at least 500 cells, at least 1,000 cells, at least 5,000 cells, at least 10,000 cells, at least 15,000 cells, at least 25,000 cells, at least 50,000 cells, at least 100,000 cells, and/or up to 200,000 cells, up to 250,000 cells, up to 500,000 cells, up to 1,000,000 cells, or more). Combinations of these ranges (e.g., at least 2 cells and less than or equal to 1,000,000 cells, at least 15,000 cells and less than or equal to 25,000 cells) are possible. The multiple electrolytic cells may be fluidically arranged in parallel and/or in series.

The electrolytic cell may drive one or more reactions ultimately producing base-rich product solutions and acid-rich product solutions, as discussed below. The electrolytic cell may drive one or more of such reactions upon application of an electrical potential difference across the electrolytic cell. The potential difference may be applied across the anode and the cathode such that the thermodynamic barrier (and in some instances kinetic barrier) to the overall cell reaction is overcome, thereby initiating the cell reaction to occur via electron transfers that effect the respective half reactions. The magnitude of the electrical potential difference may be greater than or equal to 0.5 V, greater than or equal to 0.9 V, greater than or equal to 1.0 V, greater than or equal to 1.3 V, and/or up to 1.5 V, up to 1.8 V, up to 2 V, up to 2.5 V, up to 3 V, or higher. Combinations of these ranges (e.g., greater than or equal to 0.5 V and less than or equal to 3 V, greater than or equal to 0.9 and less than or equal to 1.5 V) are possible.

In FIGS. 3A-3C, for example, electrical potential difference 118 is applied across electrolytic cell 102 to initiate the chemical reactions shown.

In some embodiments, the electrolysis assembly includes one or more (e.g., at least one, at least two, at least three, or more) liquid inlets. The aqueous input stream may enter the electrolytic cell via one or more of these inlets. The liquid inlets may be configured to supply dissolved ions to the anode and/or the cathode. In some embodiments, one or more of the liquid inlets are part of the electrolytic cell itself, although in other embodiments, the liquid inlets are upstream of the cell (e.g., connected to a separate conduit that feeds the cell or an upstream unit operation within the assembly). In some embodiments, a single liquid inlet feeds both the anode and the cathode (and/or a third chamber between anolyte and catholyte chambers). However, in other embodiments, a first liquid inlet supplies dissolved ions to the cathode (e.g., as part of a catholyte solution) and a second liquid inlet supplies dissolved ions to the anode (e.g., as part of an anolyte solution).

In the embodiment shown in FIG. 3A, aqueous input stream 116 (e.g., comprising the dissolved cations and dissolved anions) is fed as catholyte into catholyte chamber 120 via liquid inlet 119 (and electrolyte solution 128 is fed as anolyte into anolyte chamber 121 via liquid inlet 127). In the embodiment shown in FIG. 3B, aqueous input stream 116 (e.g., comprising the dissolved cations and dissolved anions) is fed as anolyte into anolyte chamber 121 via liquid inlet 119 (and electrolyte solution 128 is fed as catholyte into catholyte chamber 120 via liquid inlet 127). In the embodiment shown in FIG. 3C, aqueous input stream 116 (e.g., comprising the dissolved cations and dissolved anions) is fed into electrolyte chamber 122 via liquid inlet119 (and electrolyte solution 128 is fed as catholyte into catholyte chamber 120 via liquid inlet 127, and also electrolyte solution 128 is fed as anolyte into anolyte chamber 121 via liquid inlet 127).

In some embodiments, the electrolysis assembly includes two or more (e.g., at least two, at least three, or more) liquid outlets. The reaction products from one or more chemical reactions initiated by the application of the electrical potential difference may be output from the electrolysis assembly via these outlets. For example, the electrolysis assembly may include a first electrolysis assembly liquid outlet and a second electrolysis assembly liquid outlet.

The first electrolysis assembly liquid outlet may be configured to output a base-rich product solution (e.g., generated in a catholyte chamber). For example, the first electrolysis assembly liquid outlet may be in fluid communication with a catholyte chamber of the electrolytic cell. For example, in FIGS. 3A-3C, first liquid outlet 123 is in fluid communication with catholyte chamber 120 of electrolytic cell 102. At least a portion of base-rich product solution 103 generated by electrolysis assembly 101 may be output by first liquid outlet 123 (e.g., to a conduit to be transported to a downstream process and/or to be collected).

The second electrolysis assembly liquid outlet may be configured to output an acid-rich product solution (e.g., generated in an anolyte chamber). For example, the second electrolysis assembly liquid outlet may be in fluid communication with an anolyte chamber of the electrolytic cell. For example, in FIGS. 3A-3C, second liquid outlet 124 is in fluid communication with anolyte chamber 121 of electrolytic cell 102. At least a portion of acid-rich product solution 104 generated by electrolysis assembly 101 may be output by second liquid outlet 124 (e.g., to a conduit to be transported to a downstream process and/or to be collected). While the liquid outlets are shown as being directly part of electrolytic cell 102 in FIGS. 3A-3C, other configurations are possible. For example, while in some embodiments, one or more of the liquid outlets are part of the electrolytic cell itself, in other embodiments, the liquid outlets are downstream of the cell (e.g., connected to a separate conduit that feeds the downstream processes such as chambers or reactors for further reactivity (e.g., as in a chloralkali assembly in which hydrogen gas and chlorine gas electrolytic products are reacted to form HCl to produce the acid-rich product solution)).

As mentioned above, the electrolytic cell may comprise an anode and a cathode. In an electrolytic cell, the anode, also referred to as the positive electrode, is used to promote an electrochemical oxidation half reaction. For example, in the embodiments shown in FIGS. 3A-3C, anode 125 is configured to perform the hydrogen oxidation reaction, in which hydrogen gas is oxidized to form protons: ½ H₂→H⁺+e⁻ (with the electrons collected by anode 125 and transported to cathode 126 as part of the electrical circuit). Any of a variety of materials may be used for the anode, generally including an electronically conductive solid. In some embodiments, the anode comprises a conductive metal or metal alloy such as platinum, nickel, stainless steel, titanium, platinized titanium, silver, gold, or combinations thereof). In some embodiments, the anode is a gas diffusion electrode and/or comprises a gas diffusion layer (e.g., a carbon and/or metallic gas diffusion electrode and/or layer). In some embodiments, the anode comprises a catalyst configured to accelerate the reaction to occur at the anode (e.g., hydrogen oxidation).

In some embodiments, the electrolytic cell comprises an anolyte chamber. The anolyte chamber may be in fluid communication with at least a portion of the anode (e.g., the anode may be at least partially submerged in anolyte that is present in the anolyte chamber). At least a portion (or all) of the anode may be located within the anolyte chamber. In the embodiments shown in FIGS. 3A-3C, anode 125 is submerged in anolyte in anolyte chamber 121.

In an electrolytic cell, the cathode, also referred to as the negative electrode, is used to promote an electrochemical reduction half reaction. For example, in the embodiments shown in FIGS. 3A-3C, cathode 126 is configured to perform the hydrogen evolution reaction, in which hydrogen gas is generated by the reduction of water (or protons from water): 2H₂O+2e⁻→H₂+2OH⁻ (with the electrons provided by cathode 126 after having been transported to cathode 126 from anode 125 as part of the electrical circuit). Any of a variety of materials may be used for the cathode, generally including an electronically conductive solid (e.g., a conductive metal or metal alloy such as platinum, nickel, ruthenium, stainless steel, or combinations thereof). As one example, the cathode may comprises nickel coated with a platinum group metal (e.g., platinum). However, in some embodiments, the cathode comprises a nickel substrate with a catalyst coating comprising a non-platinum group metal such as a non-platinum group transition metal. In some embodiments, the cathode comprises a catalyst configured to accelerate the reaction to occur at the cathode (e.g., hydrogen evolution).

In some embodiments where the hydrogen evolution reaction is performed at the cathode and the hydrogen oxidation reaction is performed at the anode, the hydrogen gas reactant at the anode is supplied from the product hydrogen gas generated at the cathode. For example, a conduit may be configured to collect hydrogen gas produced in the catholyte chamber and transport the hydrogen gas to the anolyte chamber for consumption.

In some embodiments, the electrolytic cell comprises a catholyte chamber. The catholyte chamber may be in fluid communication with at least a portion of the cathode (e.g., the cathode may be at least partially submerged in catholyte that is present in the catholyte chamber). At least a portion (or all) of the cathode may be located within the catholyte chamber. In the embodiments shown in FIGS. 3A-3C, cathode 126 is submerged in catholyte in catholyte chamber 120.

In some embodiments, the catholyte chamber and the anolyte chamber are separated by at least one separator (e.g., comprising a membrane and/or diaphragm). In some embodiments, the separator is not ion-selective. For example, the separator may comprise a porous media and separate the electrolyte compartments by limiting convective flow and/or molecular diffusion, without substantial (or any) ion selectivity. However, in some embodiments, the separator is ion-selective. For example, in some embodiments, the catholyte chamber and the anolyte chamber are separated by at least one ion-selective membrane (e.g., at least one ion-selective membrane, at least two ion selective membranes, or more). In this context, the separation refers to the membrane limiting or preventing transport of at least one type of ion from the catholyte chamber to the anolyte chamber or vice versa. Any of a variety of ion-selective membranes may be used. For example, the membrane may be a semi-permeable membrane (e.g., a semi-permeable polymer membrane, ceramic membrane, or combination thereof).

In some embodiments, at least one ion-selective membrane in the electrolytic cell comprises a cation-selective membrane. In some such embodiments, the aqueous input stream is transported to the anolyte chamber. For example, in the embodiment shown in FIG. 3B, aqueous input stream 116 comprising dissolved salt MX is transported to anolyte chamber 121 via liquid inlet 119, and cations M⁺ (e.g., sodium ions, and/or potassium ions) migrate through cation-selective membrane 129 from anolyte chamber 121 to catholyte chamber 120. Cation M⁺ helps maintain charge neutrality and can be expelled from catholyte chamber 120 as part of base-rich product solution 103 (e.g., as a counter-cation to electrogenerated basic species such as hydroxide ions).

In some embodiments, at least one ion-selective membrane in the electrolytic cell comprises an anion-selective membrane. In some such embodiments, the aqueous input stream is transported to the catholyte chamber. For example, in the embodiment shown in FIG. 3A, aqueous input stream 116 comprising dissolved salt MX is transported to catholyte chamber 120 via liquid inlet 119, and anions X⁻ (e.g., halide ions such as chloride ions, sulfate ions, nitrate ions, phosphate ions) migrate through anion-selective membrane 130 from catholyte chamber 120 to anolyte chamber 121. Anion X⁻ helps maintain charge neutrality and can be expelled from anolyte chamber 121 as part of acid-rich product solution 104 (e.g., as a counter-anion to electrogenerated acidic species such as protons/hydronium ion or to other cations that may be present).

In some embodiments, the electrolytic cell further comprises an electrolyte chamber other than the catholyte chamber and the anolyte chamber. The electrolyte chamber may be separated from the catholyte chamber by a cation selective membrane. For example, in FIG. 3C, electrolyte chamber 122 is separated from catholyte chamber 120 by cation-exchange membrane 129, where cations M⁺ can migrate from electrolyte chamber 122 to catholyte chamber 120. In some embodiments, the electrolyte chamber is separated from the anolyte chamber by an anion exchange membrane. For example, in FIG. 3C, electrolyte chamber 122 is separated from anolyte chamber 121 by anion-exchange membrane 130, where anions X⁻ can migrate from electrolyte chamber 122 to anolyte chamber 121. In some embodiments in which there is an electrolyte chamber separated from the anolyte chamber and the catholyte chamber in the electrolytic cell, the aqueous input stream comprising dissolved salt is transported to that electrolyte chamber (e.g., via one of the electrolysis assembly inlets). For example, in FIG. 3C, aqueous input stream 116 comprising dissolved salt MX is fed to electrolyte chamber 122 via liquid inlet 119. In some embodiments, the electrolyte chamber is in fluid communication with a liquid outlet. For example, in some embodiments, an aqueous input stream comprising concentrated dissolved salt MX is transported via a liquid inlet to the electrolyte chamber, and an electrolyte outlet stream is output from the electrolyte chamber via a liquid outlet, with the electrolyte outlet stream having a lower concentration of dissolved MX than the aqueous input stream (e.g., by a factor of at least 1.01, at least 1.02, at least 1.05, at least 1.1, at least 1.2, at least 1.5, at least 2, at least 5, at least 10, at least 20, and/or up to 50, up to 100, or more). Combinations of these ranges (e.g., at least 1.01 and less than or equal to 100, at least 1.01 and less than or equal to 5) are possible. As an illustrative example, if an electrolyte outlet stream has a concentration of dissolved MX of 0.2 M and the aqueous input stream has a concentration of MX of 1.0 M, then the electrolyte outlet stream has a concentration of MX that is lower than that of the aqueous input stream by a factor of 5 because 0.2 M times 5 equals 1.0 M.

Non-limiting examples of suitable electrolysis assembly and electrolytic cell configurations for at least some embodiments are described in U.S. Pat. No. 7,790,012 by Kirk et al., issued Sep. 7, 2010, which is incorporated herein by reference in its entirety for all purposes.

While the hydrogen evolution and hydrogen oxidation half-cell reactions are described in detail above and below, those reactions are illustrative, and other chemistries may be employed. For example, the electrolytic assembly may be configured to perform water electrolysis, where the hydrogen evolution reaction at the cathode is coupled to the oxygen evolution reaction at the anode. As another example, the electrolytic assembly may be configured to perform the oxygen reduction reaction at the cathode and one or more of the hydrogen oxidation reaction, the chlorine gas (Cl₂) evolution reaction, or the oxygen evolution reaction at the anode. As yet another example, the electrolytic assembly may be configured to perform a carbon dioxide reduction at the cathode and the oxygen evolution reaction at the anode.

In some embodiments, the electrolysis cell is configured to be operated as an electrodialysis cell. The cathode electrolysis and anode electrolysis half-reactions in an electrolytic cell configured as an electrodialysis cell may create electric fields that drive separation of cations and anions (e.g., using semi-permeable membranes such as ion-selective membranes). In some embodiments, the electrolytic cell comprises a cathode, an anode, and two or more semi-permeable membranes (e.g., two or more ion-selective membranes) separating the cathode and the anode. In some embodiments, the electrolysis cell comprises a bipolar membrane as at least one of the semi-permeable membranes. A bipolar membrane may comprise an anion-selective membrane layer and a cation-selective membrane layer configured to create a junction at an interface between the anion-selective membrane layer and the cation-selective membrane layer (e.g., upon being pressed together). The bipolar membrane may be configured to promote dissociation of water at the junction to form protons (e.g., as hydronium cations) and hydroxide anions. In some, but not necessarily all embodiments, the bipolar membrane comprises a water dissociation catalyst, which may enhance the rate of water dissociation.

FIG. 3D shows a schematic cross-sectional diagram of an embodiment in which electrolytic cell 102 is configured as an electrodialysis cell comprising bipolar membrane 141. Application of an electrical potential difference across electrolytic cell 102 may initiate a cathode electrolysis half reaction at cathode 126 and an anode half reaction at anode 125 of electrolytic cell 102. The cathode electrolysis half reaction may generate negative charge near cathode 126, thereby generating an electric field attracting cations. The anode electrolysis half reaction may generate positive charge near anode 125, thereby generating an electric field attracting anions. Bipolar membrane 141 comprises cation-selective membrane 129a and anion-selective membrane 130a configured to dissociate water into H⁺ and OH⁻. The dissociated H⁺ may diffuse from cation-selective membrane 129a of bipolar membrane 141 toward cathode 126, while the dissociated OH⁻ may diffuse from anion-selective membrane 130a toward anode 125. Additionally, anion-selective membrane 130b may separate cation-selective membrane 129a and cathode 126, thereby reducing or stopping transport of the diffusing H⁺ toward cathode 126 while permitting dissolved anion X⁻ from dissolved salt MX (e.g., NaCl) to cross anion-selective membrane 130b in the opposite direction. As a result, a product solution comprising dissolved HX may be formed in the space between anion-selective membrane 130b and cation-selective membrane 129a. Such a product solution may form some or all of an anolyte product stream (e.g., an acid-rich product stream) output by electrolytic cell 102.

Meanwhile, in FIG. 3D, cation-selective membrane 129b may separate anion-selective membrane 130a and anode 125, thereby reducing or stopping transport of the diffusing OH⁻ toward anode 125 while permitting dissolved metal cation M⁺ from dissolved salt MX (e.g., NaCl) to cross cation-selective membrane 129b in the opposite direction. As a result, a product solution comprising dissolved MOH may be formed in the space between cation-selective membrane 129b and anion-selective membrane 130a. Such a product solution may form some or all of the base-rich product solution output by electrolytic cell 102.

FIG. 3E shows a schematic cross-sectional illustration of another embodiment in which electrolytic cell 102 is configured as an electrodialysis cell, but without use of a separate anion-selective membrane in addition to that in bipolar membrane 141. As before, the dissociated H⁺ may diffuse from cation-selective membrane 129a of bipolar membrane 141 toward cathode 126, while the dissociated OH— may diffuse from anion-selective membrane 130a toward anode 125. The diffusing H⁺ may become exposed to solution comprising X⁻ from dissolved salt MX (e.g., NaH₂PO₄). As a result, a product solution comprising dissolved HX (e.g., H₃PO₄) may be formed on the side of cation-selective membrane 129a closest to cathode 126. Such a product solution may form some or all of an anolyte product stream (e.g., an acid-rich product stream) output by electrolytic cell 102.

Meanwhile, in FIG. 3E, cation-selective membrane 129b may separate anion-selective membrane 130a and anode 125, thereby reducing or stopping transport of the diffusing OH⁻ toward anode 125 while permitting dissolved metal cation M⁺ from dissolved salt MX (e.g., NaH₂PO₄) to cross cation-selective membrane 129b in the opposite direction. As a result, a product solution comprising dissolved MOH (e.g., NaOH) may be formed in the space between cation-selective membrane 129b and anion-selective membrane 130a. Such a product solution may form some or all of the base-rich product stream output by electrolytic cell 102.

The arrangements of ion-selective membranes shown in FIGS. 3D-3E may be repeated any of a variety of times to form a stack between the cathode, which may be at one end of a stack, and the anode, which may be at the opposite end of the stack.

In some embodiments, the cathode electrolysis half reaction of the electrodialysis cell is the hydrogen evolution reaction. In some embodiments, the cathode electrolysis half reaction of the electrodialysis cell is the oxygen reduction reaction. In some embodiments, the cathode electrolysis half reaction of the electrodialysis cell is a carbon dioxide reduction reaction. In some embodiments, the anode electrolysis half reaction of the electrodialysis cell is the hydrogen oxidation reaction. In some embodiments, the anode electrolysis half reaction of the electrodialysis cell is the oxygen evolution reaction. In some embodiments, the cathode electrolysis half reaction of the electrodialysis cell is the hydrogen evolution reaction and the anode electrolysis half reaction is the oxygen evolution reaction. In some embodiments, the cathode electrolysis half reaction of the electrodialysis cell is the hydrogen evolution reaction and the anode electrolysis half reaction is the hydrogen oxidation reaction. In some embodiments, the cathode electrolysis half reaction of the electrodialysis cell is the oxygen reduction reaction and the anode electrolysis half reaction is the oxygen evolution reaction. In some embodiments, the cathode electrolysis half reaction of the electrodialysis cell is a carbon dioxide reduction reaction and the anode electrolysis half reaction is the oxygen evolution reaction. In some embodiments, the cathode electrolysis half reaction of the electrodialysis cell is the oxygen reduction reaction and the anode electrolysis half reaction is the hydrogen oxidation reaction.

In some embodiments, the cathode electrolysis half reaction of the electrolytic cell (e.g., in the catholyte chamber) is the hydrogen evolution reaction. In some embodiments, the cathode electrolysis half reaction of the electrolytic cell (e.g., in the catholyte chamber) is the oxygen reduction reaction. In some embodiments, the cathode electrolysis half reaction of the electrolytic cell (e.g., in the catholyte chamber) is a carbon dioxide reduction reaction. In some embodiments, the anode electrolysis half reaction of the electrolytic cell (e.g., in the anolyte chamber) is the hydrogen oxidation reaction. In some embodiments, the anode electrolysis half reaction of the electrolytic cell (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the hydrogen evolution reaction and the anode electrolysis half reaction (e.g., in the anolyte chamber) is the hydrogen oxidation reaction. In some embodiments, the cathode electrolysis half reaction of the electrolytic cell (e.g., in the catholyte chamber) is the oxygen reduction reaction and the anode electrolysis half reaction (e.g., in the anolyte chamber) is the oxygen evolution reaction. In some embodiments, the cathode electrolysis half reaction of the electrolytic cell (e.g., in the catholyte chamber) is a carbon dioxide reduction reaction and the anode electrolysis half reaction (e.g., in the anolyte chamber) is the oxygen evolution reaction. In some embodiments, the cathode electrolysis half reaction of the electrolytic cell (e.g., in the catholyte chamber) is the oxygen reduction reaction and the anode electrolysis half reaction (e.g., in the anolyte chamber) is the hydrogen oxidation reaction. In some such embodiments, employing the oxygen reduction reaction and the hydrogen oxidation reaction as the respective half-reactions in the cathode and anode can facilitate the generation of electricity in a system capable of capturing and in some instances releases carbon dioxide.

As discussed above, a base-rich product solution may be formed as a result of the one or more reactions performed via the electrolytic cell. For example, in FIG. 2, at least a portion of base-rich product solution is output from electrolysis assembly 101 as stream 103. The base-rich product solution may be formed, for example, in the catholyte chamber of the electrolytic cell. The base-rich product solution may be formed using a batch, semi-batch, or continuous process involving the electrolytic cell.

The base-rich product solution may comprise electrogenerated basic species. The electrogenerated basic species may be dissolved in an aqueous solution. The electrogenerated basic species may be a direct or indirect product of the one or more chemical reactions performed in the electrolysis assembly. The electrogenerated basic species may be a source of alkalinity for the solution. For example, the electrogenerated basic species may be a species whose conjugate acid has a relatively high pKₐ. The basic species may have a conjugate acid having a pKₐ of greater than or equal to 10, greater than or equal to 10.3, greater than or equal to 10.5, greater than or equal to 11, greater than or equal to 12, greater than or equal to 14, greater than or equal to 15, and/or up to 15.7, up to 16, or greater in water at a temperature of 298 K. Combinations of these ranges are possible. In some embodiments, the electrogenerated basic species comprises hydroxide ions (OH⁻). One way in which the hydroxide ions may be generated is from the hydrogen evolution reaction (e.g., in the catholyte chamber). As another example, the electrogenerated species may comprise carbonate ions (CO₃²⁻). The carbonate ions may be generated from deprotonation of dissolved carbonic acid (from dissolved carbon dioxide) by electrogenerated hydroxide ions, either in the catholyte chamber or in a different component of the system.

The basic species (e.g., hydroxide ions) may be present in the base-rich product solution in a relatively high concentration (which may promote effective carbon dioxide capture elsewhere in the system). It should be understood that the name “base-rich product solution” is used for convenience in identifying the solution, and is not meant to imply any particular absolute or relative concentration of base in the solution. In some embodiments, the basic species (e.g., hydroxide ions) is present in the base-rich product solution at a concentration of greater than or equal to 0.1 M, greater than or equal to 0.2 M, greater than or equal to 0.5 M, greater than or equal to 1 M, greater than or equal to 1.5 M, greater than or equal to 2 M, and/or up to 3 M, up to 5 M, up to 10 M, or greater. Combinations of these ranges (e.g., greater than or equal to 0.1 M and less than or equal to 10 M, or greater than or equal to 1 M and less than or equal to 10 M) are possible.

In some embodiments, the molar ratio of the concentration of the basic species (e.g., hydroxide ions) in the base-rich product solution to the concentration of the basic species in the stream fed to the catholyte compartment (e.g., the aqueous input stream or a different electrolyte stream) is at least 1.005, at least 1.01, at least 1.05, at least 1.1, at least 1.2, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, base-rich product solution has a relatively high pH. For example, in some embodiments, the base-rich product solution has a pH of greater than or equal to 8, greater than or equal to 9, greater than or equal to 10, greater than or equal to 11, greater than or equal to 12, greater than or equal to 13, greater than or equal to 14, and/or up to 15, up to 16, or greater. Combinations of these ranges are possible.

In some embodiments, the base-rich product solution comprises at least some of the cations (e.g., the metal cations and/or ammonium cations discussed above). The cations may be from the aqueous input stream. The cations in the base-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the cations in the aqueous input stream. For example, an aqueous input solution comprising dissolved MX (e.g., NaCl) may be transported to the electrolytic cell, and a base-rich product solution comprising dissolved MOH (e.g., NaOH) may be produced by the electrolytic cell.

At least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the base-rich product solution may be transported to the gas-liquid contact vessel. For example, the base-rich product solution may form at least a portion (e.g., at least 10 wt %, at least 25 wt %, at least 50 wt %, at least 75 wt %, at least 90 wt %, at least 95 wt %, at least 98 wt %, at least 99 wt %, at least 99.9 wt %, or all) of the contact vessel liquid inlet. In the embodiment shown in FIG. 2, for example, a liquid outlet of electrolysis assembly 101 (e.g., first liquid outlet 123 in FIGS. 3A-3C) is fluidically connected to contact vessel liquid inlet 164) such that base-rich product solution 103 can be transported to contact vessel 131 as part of contact vessel liquid inlet stream 106.

As discussed above, an acid-rich product solution may be formed as a result of the one or more reactions performed via the electrolytic cell. For example, in FIG. 2 at least a portion of acid-rich product solution is output from electrolysis assembly 101 as stream 104. The acid-rich product solution may be formed, for example, in the anolyte chamber of the electrolytic cell. The acid-rich product solution may be formed using a batch, semi-batch, or continuous process involving the electrolytic cell.

The acid-rich product solution may comprise electrogenerated acidic species. The electrogenerated acidic species may be dissolved in an aqueous solution. The electrogenerated acidic species may be a direct or indirect product of the one or more chemical reactions performed in the electrolysis assembly. The electrogenerated acidic species may be a source of acidity for the solution. For example, the electrogenerated acidic species may have a relatively low pKₐ. The acidic species may have a pKₐ of less than or equal to 7, less than or equal to 6, less than or equal to 5, less than or equal to 4, less than or equal to 3, less than or equal to 2.5, less than or equal to 2, less than or equal to 1, less than or equal to 0, less than or equal to −1, and/or as low as −1.7, as low as −2, or less in water at a temperature of 298 K. Combinations of these ranges are possible. In some embodiments, the electrogenerated acidic species comprises hydronium ions (H₃O⁺). One way in which the hydronium ions may be generated is from the hydrogen oxidation reaction (e.g., in the anolyte chamber). The protons generated by the hydrogen oxidation reaction protonate water molecules, thereby forming the hydronium ions. As another example, the electrogenerated acidic species may comprise a weak acid. The weak acid may be, for example, an organic weak acid. Examples of organic weak acids include, but are not limited to acetic acid, acrylic acid, benzoic acid, chloroacetic acid, citric acid, dichloroacetic acid, formic acid, hexanoic acid, maleic acid, malic acid, malonic acid, heptanoic acid, octanoic acid, oxalic acid, phthalic acid, picric acid, succinic acid, and/or trichloroacetic acid. In some embodiments, the weak acid is an inorganic weak acid. Examples of inorganic weak acids include, but are not limited to boric acid, chromic acid, perchloric acid, periodic acid, phosphoric acid, dihydrogen phosphate (e.g., as dissolved alkali dihydrogen phosphate such as dissolved potassium dihydrogen phosphate), pyrophosphoric acid, sulfurous acid, and/or tetraboric acid.

The weak acid may be a weak Bronsted Lowry acid present in its protonated form but with a sufficiently high acidity to ultimately drive acid-base equilibria for carbon dioxide release (e.g., in a downstream process). For example, the acidic species may comprise phosphoric acid (H₃PO₄). The phosphoric acid may be generated from protonation of dissolved dihydrogen phosphate by electrogenerated hydronium ions, either in the anolyte chamber or in a different component of the system. As another example, the acidic species may comprise dihydrogen phosphate (H₂PO₄⁻). The dihydrogen phosphate may be generated from protonation of dissolved monohydrogen phosphate by electrogenerated hydronium ions, either in the anolyte chamber or in a different component of the system. As yet another example, the acidic species may comprise boric acid (H₃BO₃). The boric acid may be generated from protonation of dissolved dihydrogen borate by electrogenerated hydronium ions, either in the anolyte chamber or in a different component of the system. As yet another example, the acidic species may comprise acetic acid. The acetic acid may be generated from protonation of dissolved acetate by electrogenerated hydronium ions, either in the anolyte chamber or in a different component of the system. As yet another example, the acidic species may comprise benzoic acid. The benzoic acid may be generated from protonation of dissolved benzoate by electrogenerated hydronium ions, either in the anolyte chamber or in a different component of the system. As yet another example, the acidic species may comprise formic acid. The formic acid may be generated from protonation of dissolved formate by electrogenerated hydronium ions, either in the anolyte chamber or in a different component of the system.

The acidic species (e.g., hydronium ions) may be present in the acid-rich product solution in a relatively high concentration (which may promote effective carbon dioxide release in the electrolytic cell and/or elsewhere in the system). It should be understood that the name “acid-rich product solution” is used for convenience in identifying the solution, and is not meant to imply any particular absolute or relative concentration of acid in the solution. In some embodiments, the acidic species (e.g., hydronium ions) is present in the acid-rich product solution at a concentration of greater than or equal to 0.000001 M, greater than or equal to 0.00001 M, greater than or equal to 0.0001 M, greater than or equal to 0.001 M, greater than or equal to 0.01 M, greater than or equal to 0.02 M greater than or equal to 0.05 M, greater than or equal to 0.1 M, greater than or equal to 0.2 M, greater than or equal to 0.5 M, greater than or equal to 1 M, and/or up to 1.5 M, up to 2 M, up to 3 M, or greater. In some embodiments, the acidic species (e.g., hydronium ions) is present in the acid-rich product solution at a concentration of greater than or equal to 0.1 M, greater than or equal to 0.2 M, greater than or equal to 0.5 M, greater than or equal to 1 M, and/or up to 1.5 M, up to 2 M, up to 3 M, or greater. Combinations of these ranges (e.g., greater than or equal to 0.05 M and less than or equal to 3 M, greater than or equal to 0.1 and less than or equal to 2 M) are possible. Another example of a combination of these ranges is greater than or equal to 0.000001 M and less than or equal to 3 M. In some embodiments, the molar ratio of the concentration of the acidic species (e.g., hydronium ions) in the acid-rich product stream to the concentration of the acidic species in the stream fed to the anolyte compartment (e.g., the aqueous input stream or a different electrolyte stream) is at least 1.005, at least 1.01, at least 1.05, at least 1.1, at least 1.5, at least 2, at least 5, at least 10, at least 50, at least 100, at least 1000, at least 10,000, at least 100,000, at least 1,000,000, at least 10,000,000, and/or up to 100,000,000, up to 1,000,000,000, or more. Combinations of these ranges (e.g., at least 1.005 and less than or equal to 1,000,000,000, or at least 1.01 and less than or equal to 1,000,000) are possible.

In some embodiments, acid-rich product solution has a relatively low pH. For example, in some embodiments, the acid-rich product solution has a pH of less than or equal to 6, less than or equal to 5, less than or equal to 4, less than or equal to 3, less than or equal to 2, less than or equal to 1, less than or equal to 0, and/or as low as −1, as low as −2, or lower. Combinations of these ranges are possible.

In some embodiments, the acid-rich product solution comprises at least some of the anions (e.g., the halide, sulfate, nitrate, and/or phosphate anions discussed above). The anions may be from the aqueous input stream. For example, the anions in the acid-rich product solution may constitute at least a portion (e.g., at least 0.05 mol %, at least 0.1 mol %, at least 0.5 mol %, at least 1 mol %, at least 2 mol %, at least 5 mol %, at least 10 mol %, at least 25 mol %, and/or up 50 mol %, up 75 mol %, up 90 mol %, up to 95 mol %, up to 98 mol %, up to 99 mol %, or more) of the anions in the aqueous input stream. For example, an aqueous input solution comprising dissolved MX (e.g., NaCl) may be transported to the electrolytic cell, and an acid-rich product solution comprising dissolved HX (e.g., HCl) may be produced by the electrolytic cell.

In some embodiments, the method for removing dissolved metal cation impurities from an aqueous stream comprises: exposing, in the gas-liquid contact vessel, basic species to carbon dioxide from the input gas stream to generate: a carbon dioxide-lean output gas stream having a lower concentration of carbon dioxide than the input gas stream, and a capture stream comprising dissolved carbonate anions formed from the carbon dioxide; transporting at least a portion of the capture stream out of the gas-liquid contact vessel to form at least a portion of the metal cation impurity salt precipitation stream; and exposing the aqueous metal cation impurity-rich source stream comprising dissolved metal cation impurities (e.g., present at a total concentration of greater than or equal to 0.001 mg/L) to the metal cation impurity salt precipitation stream to produce the metal cation impurity solids-containing stream comprising a solid salt comprising at least some of the metal cation impurities (e.g., a solid carbonate salt comprising at least some of the metal cation impurities). In some such embodiments, the ratio of the molar concentration of at least one dissolved metal cation impurity in the aqueous metal cation impurity-rich source stream to the molar concentration of the at least one dissolved metal cation impurity in the metal cation impurity solids-containing stream is greater than or equal to 2.

As used herein, two elements are in fluidic communication with each other (or, equivalently, in fluid communication with each other) when fluid may be transported from one of the elements to the other of the elements without otherwise altering the configurations of the elements or a configuration of an element between them (such as a valve). Two conduits connected by an open valve (thus allowing for the flow of fluid between the two conduits) are considered to be in fluidic communication with each other. In contrast, two conduits separated by a closed valve (thus preventing the flow of fluid between the conduits) are not considered to be in fluidic communication with each other.

As used herein, two elements are fluidically connected to each other when they are connected such that, under at least one configuration of the elements and any intervening elements, the two elements are in fluidic communication with each other. Two components connected by a valve and conduits that permit flow between the components in at least one configuration of the valve would be said to be fluidically connected to each other. To further illustrate, two components that are connected by a valve and conduits that permit flow between the components in a first valve configuration but not a second valve configuration are considered to be fluidically connected to each other both when the valve is in the first configuration and when the valve is in the second configuration. In contrast, two components that are not connected to each other (e.g., by a valve, another conduit, or another component) in a way that would permit fluid to be transported between them under any configuration would not be said to be fluidically connected to each other. Elements that are in fluidic communication with each other are always fluidically connected to each other, but not all elements that are fluidically connected to each other are necessarily in fluidic communication with each other.

Various components are described herein as being fluidically connected. Fluidic connections may be either direct fluidic connections or indirect fluidic connections. Generally, a direct fluidic connection exists between a first region and a second region (and the two regions are said to be directly fluidically connected to each other) when they are fluidically connected to each other and when the composition of the fluid at the second region of the fluidic connection has not substantially changed relative to the composition of the fluid at the first region of the fluidic connection (i.e., no fluid component that was present in the first region of the fluidic connection is present in a weight percentage in the second region of the fluidic connection that is more than 5% different from the weight percentage of that component in the first region of the fluidic connection). As an illustrative example, a stream that connects first and second unit operations, and in which the pressure and temperature of the fluid is adjusted but the composition of the fluid is not altered, would be said to directly fluidically connect the first and second unit operations. If, on the other hand, a separation step is performed and/or a chemical reaction is performed that substantially alters the composition of the stream contents during passage from the first component to the second component, the stream would not be said to directly fluidically connect the first and second unit operations. In some embodiments, a direct fluidic connection between a first region and a second region can be configured such that the fluid does not undergo a phase change from the first region to the second region. In some embodiments, the direct fluidic connection can be configured such that at least 50 wt % (or at least 75 wt %, at least 90 wt %, at least 95 wt %, or at least 98 wt %) of the fluid (e.g., liquid) in the first region is transported to the second region via the direct fluidic connection. Any of the fluidic connections described herein may be, in some embodiments, direct fluidic connections. In other cases, the fluidic connections may be indirect fluidic connections.

U.S. Provisional Patent Application No. 63/640,084, filed Apr. 29, 2024, and entitled “Metal Cation Removal From Liquid Streams Using Captured Carbon Dioxide,” and U.S. Provisional Patent Application No. 63/687,639, filed Aug. 27, 2024, and entitled “Metal Cation Removal From Liquid Streams Using Captured Carbon Dioxide,” are each incorporated herein by reference in its entirety for all purposes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrase “at least a portion” means some or all. “At least a portion” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for removing dissolved metal cation impurities from an aqueous stream, comprising:
exposing an aqueous metal cation impurity-rich source stream comprising dissolved metal cation impurities present at a total concentration of greater than or equal to 0.001 mg/L to a metal cation impurity salt precipitation stream to produce a metal cation impurity solids-containing stream comprising a solid salt comprising at least some of the metal cation impurities;
wherein the metal cation impurity salt precipitation stream is formed at least in part by a method comprising:
exposing, in a gas-liquid contact vessel, basic species to carbon dioxide from an input gas stream to generate:
a carbon dioxide-lean output gas stream having a lower concentration of carbon dioxide than the input gas stream; and
a capture stream comprising dissolved carbonate anions formed from the carbon dioxide; and
transporting at least a portion of the capture stream out of the gas-liquid contact vessel to form at least a portion of the metal cation impurity salt precipitation stream;
wherein a ratio of the molar concentration of at least one dissolved metal cation impurity in the aqueous metal cation impurity-rich source stream to the molar concentration of the at least one dissolved metal cation impurity in the metal cation impurity solids-containing stream is greater than or equal to 2.

2. The method of claim 1, wherein the aqueous metal cation impurity-rich source stream is or is derived from a brine, wastewater, groundwater, sewage, seawater, acidulated/digested minerals, salt flats, and/or industrial process streams.

3. The method of claim 1, wherein the metal cation impurities are present in the aqueous metal cation impurity-rich source stream at a total concentration of greater than or equal to 10 mg/L.

4. The method of claim 1, wherein at least some of the metal cation impurities are alkaline earth metal cations.

5. The method of claim 1, wherein the metal cation impurity salt precipitation stream comprises dissolved carbonate anions at a concentration of greater than or equal to 0.1 M.

6. The method of claim 1, wherein the metal cation impurity salt precipitation stream comprises dissolved hydroxide anions at a concentration of greater than or equal to 0.0001 M.

7. The method of claim 1, wherein a ratio of the total molar concentration of the dissolved metal cation impurities in the aqueous metal cation impurity-rich source stream to the total molar concentration of dissolved metal cation impurities in the metal cation impurity solids-containing stream is greater than or equal to 2.

8. The method of claim 1, wherein the metal cation impurity solids-containing stream is a slurry comprising water mixed with the solid salt comprising the at least some of the metal cation impurities.

9. The method of claim 1, further comprising separating at least a portion of the solid salt from the metal cation impurity solids-containing stream.

10. The method of claim 1, wherein the basic species comprises hydroxide ions.

11. The method of claim 1, wherein the basic species is electrogenerated.

12. The method of claim 1, wherein the basic species is electrogenerated in an electrolytic cell.

13. The method of claim 1, wherein the basic species is generated by:
transporting an aqueous input stream to an electrolytic cell; and
applying an electrical potential difference across the electrolytic cell and performing one or more reactions to produce:
a base-rich product solution comprising electrogenerated basic species; and
an acid-rich product solution comprising electrogenerated acidic species.

14. The method of claim 13, wherein the aqueous input stream comprises dissolved cations, wherein the cations comprise metal cations and/or ammonium cations.

15. The method of claim 14, wherein the cations comprise alkali metal cations and/or ammonium cations.

16. The method of claim 13, wherein the aqueous input stream comprises dissolved anions, wherein the dissolved anions comprise non-hydroxide anions.

17. The method of claim 16, wherein the dissolved anions comprise halide ions, oxyanions, and/or conjugate bases of organic acids.

18. The method of claim 16, wherein the dissolved anions comprise conjugate bases of weak acids.

19. The method of claim 16, wherein the dissolved anions comprise halide ions, sulfate ions, nitrate ions, and/or phosphate ions.

20. The method of claim 16, wherein the dissolved anions comprise chloride ions.

21. The method of claim 16, wherein the dissolved anions comprise phosphate ions.

22. The method of claim 21, wherein the phosphate ions comprise orthophosphate ions (PO₄³⁻), monohydrogen phosphate ions (HPO₄²⁻), and/or dihydrogen phosphate ions (H₂PO₄⁻).

23. The method of claim 16, wherein the aqueous input stream comprises dissolved cations, wherein the cations comprise metal cations and/or ammonium cations, wherein the cations are present in the aqueous input stream at a concentration of greater than or equal to 0.1 M, and wherein the anions are present in the aqueous input stream at a concentration of greater than or equal to 0.1 M.

24. The method of claim 13, wherein the method of forming the metal cation impurity salt precipitation stream further comprises transporting at least a portion of the base-rich product solution to the gas-liquid contact vessel.

25. The method of claim 13, wherein the acidic species comprises hydronium ions.

26. The method of claim 13, wherein the acidic species comprises acetic acid.

27. The method of claim 13, wherein the acidic species comprises benzoic acid.

28. The method of claim 13, wherein the acidic species comprises formic acid.

29. The method of claim 13, wherein the acidic species comprises phosphoric acid (H₃PO₄).

30. The method of claim 13, wherein the acidic species comprises dihydrogen phosphate ions (H₂PO₄⁻).

31. The method of claim 13, wherein the acidic species comprises boric acid (H₃BO₃).

32. The method of claim 1, wherein the input gas stream comprises carbon dioxide in an amount of less than or equal to 200,000 ppm by volume.

33. The method of claim 1, wherein the input gas stream comprises carbon dioxide in an amount of less than or equal to 100,000 ppm by volume.

34. The method of claim 1, wherein the input gas stream comprises carbon dioxide in an amount of less than or equal to 1,000 ppm by volume.

35. The method of claim 12, wherein the electrolytic cell comprises a catholyte chamber and an anolyte chamber separated by at least one ion-selective membrane.

36. The method of claim 35, wherein the at least one ion-selective membrane comprises a cation-selective membrane, and wherein the aqueous input stream is transported to the anolyte chamber.

37. The method of claim 35, wherein the at least one ion-selective membrane comprises an anion-selective membrane, and wherein the aqueous input stream is transported to the catholyte chamber.

38. The method of claim 35, wherein the electrolytic cell further comprises an electrolyte chamber separated from the catholyte chamber by a cation selective membrane and separated from the anolyte chamber by an anion-selective membrane, and wherein the aqueous input stream is transported to the electrolyte chamber.

39. The method of claim 35, wherein the performing the one or more reactions comprises performing the hydrogen oxidation reaction in the anolyte chamber and performing the hydrogen evolution reaction in the catholyte chamber.

40. The method of claim 35, wherein the performing the one or more reactions comprises performing the hydrogen oxidation reaction in the anolyte chamber and performing the oxygen reduction reaction in the catholyte chamber.

41. The method of claim 35, wherein the performing the one or more reactions comprises performing the oxygen evolution reaction in the anolyte chamber and performing the oxygen reduction reaction in the catholyte chamber.

42. The method of claim 12, wherein the electrolytic cell is operated as an electrodialysis cell.

43. The method of claim 12, wherein the electrolytic cell comprises a bipolar membrane.

44. (canceled)
